(19) United States
(12) Patent Application Publication
(10) Pub. No.: US 2004/0008995 A1
(43) Pub. Date: Jan. 15, 2004

(54) Optical communication module and wavelength locker module

(75) Inventors: Haruyoshi Ono, Yamanashi (JP); Isao Baba, Yamanashi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU QUANTUM DEVICES LIMITED, Yamanashi (JP)

(21) Appl. No.: 10/614,277

(22) Filed: Jul. 8, 2003

(30) Foreign Application Priority Data
Jul. 9, 2002 (JP) 2002-200669

(51) Int. Cl. H04B 10/12

(52) U.S. Cl. 398/182

(57) ABSTRACT

An optical communication module includes: a laser light emitting unit that emits laser light; a temperature control unit that controls the temperature of the laser light emitting unit; a power intensity control unit that controls the power intensity of the laser light emitted from the laser light emitting unit; and a setting value storage unit that stores a setting value determined from an optimum power intensity that maintains a predetermined wavelength and satisfies predetermined temperature conditions and predetermined power intensity conditions, and from an optimum temperature that maintains the predetermined wavelength and satisfies the predetermined temperature conditions and the predetermined power intensity conditions. In this optical communication module, the temperature control unit and the power intensity control unit control the temperature and the power intensity of the laser light emitting unit, based on the setting value stored in the setting value storage unit.

### BACKGROUND OF THE INVENTION

1. Field of the Invention

The present invention generally relates to an optical communication module, a wavelength locker module, a setting value acquiring device for the modules, a method of acquiring setting values for the modules, a program product for acquiring the setting values, and a recording medium on which the program product is recorded. More particularly, the present invention relates to an optical communication module that can employ setting values that satisfy a power variable range and a temperature variable range, a wavelength locker module, a setting value acquiring device for the modules, a method of acquiring setting value for the modules, a program product for acquiring the setting values, and a recording medium on which the program product is recorded.

2. Description of the Related Art

To increase data transmission speed or data transmission capacity, there currently are specific standards set on optical communication. An optical module for stabilizing wavelengths, such as a wavelength locker module, is one of the optical components compliant with the standards.

The controlling ability required in a wavelength locker module has been one point of power (or power intensity) with respect to a single-wavelength laser diode (hereinafter referred to simply as “LD”). Also, a fixed standard margin (power margin) has been set on the power recently, since multi-wave tuning became necessary.

In the following, a light wavelength tuning operation using a conventional wavelength locker module will be described, with reference to the accompanying drawings.

FIG. 1 is a block diagram illustrating the structure of a measuring system that is used to determine drive conditions of an LD module 11 through a known wavelength tuning operation. As shown in FIG. 1, this measuring system includes the LD module 11, a wavelength current monitoring power source 101, a laser APC (Automatic Power Control) power source monitoring device 102, a laser temperature control monitoring device 103, and a measurement controlling computer 120.

In this structure, the wavelength current monitoring power source 101 receives a wavelength monitoring signal from a wavelength monitoring photodetector provided in the LD module 11, and measures the wavelength of laser light emitted from the LDs of the LD module 11. The measured value is then inputted into the measurement controlling computer 120 via a measuring instrument controlling GPIB 110.

The laser APC power source monitoring device 102 receives a power monitoring signal from a power monitoring photodetector that is provided in the LD module 11 and monitors the power of output light. The laser APC power source monitoring device 102 then measures the power of laser light emitted from the LDs of the LD module 11. The measured value is inputted into the measurement controlling computer 120 via the measuring instrument controlling GPIB 110. The laser APC power source monitoring device 102 also outputs an LD drive signal in accordance with an instruction inputted from the measurement controlling computer 120, and controls the power of laser light emitted from the LDs of the LD module 11.

The laser temperature control monitoring device 103 receives a temperature monitoring signal from a temperature sensor (such as a thermistor) provided in the LD module 11, and measures the temperature of the LD module 11, especially the temperature of the vicinities of laser chips. The measured value is inputted into the measurement controlling computer 120 via the measuring instrument controlling GPIB 110. The laser temperature control monitoring device 103 also outputs a temperature control signal to a device such as a Peltier device provided in the LD module 11, in accordance with an instruction inputted from the measurement controlling computer 120. By doing so, the laser temperature control monitoring device 103 controls the temperature of the LD module 11, especially the temperature of the optical resonator.

However, the wavelength and power detected by the photodetectors provided in the LD module 11 gradually shift from the actual values, as the temperature of the LD module 11 fluctuates. To avoid such an undesirable situation, the measuring system shown in FIG. 1 further includes a light wavelength measuring device 104 and a light power measuring device 105 that measure wavelength and power, respectively, of laser light emitted from the LD module 11.

The light wavelength measuring device 104 includes a photodetector that receives laser light emitted from the LD module 11, and measures the light wavelength of the laser light. The light power measuring device 105 includes a photodetector that receives laser light emitted from the LD module 11 and measures the power of the laser light. The values obtained by the light wavelength measuring device 104 and the light power measuring device 105 are inputted into the measurement controlling computer 120 via the measuring instrument controlling GPIB 110.

Referring now to FIG. 2 and FIGS. 3A and 3B, the operation performed by the measurement controlling computer 120 will be described.

As shown in FIG. 2, the measurement controlling computer 120 first sets an initial temperature T1 in the laser temperature control monitoring device 103 (step S11), and causes the laser temperature control monitoring device 103 to start ATC (Automatic Temperature Control) based on the initial temperature T1 (step S12). The measurement controlling computer 120 also sets the center P_Cent of the power variable range (equivalent to the power margin) in the laser APC power source monitoring device 102 (step S13), and causes the laser APC power source monitoring device 102 to start APC control based on the power P_Cent (step S14).

The measurement controlling computer 120 next measures the wavelength W1 (hereinafter referred to as the initial wavelength W1) of the actual output light at the initial temperature T1 (step S15), and calculates the error wavelength Δλ between the initial wavelength W1 and a target wavelength Δλ targ (step S16). Here, the value of the target wavelength λ_targ is set in advance in the measurement controlling computer 120 by a user. The calculation of the error wavelength Δλ is carried out using the following formula (1):

Δλ=λ_targ−W1 (1)

Through the calculation of the error wavelength Δλ using this formula, the measurement controlling computer 120 obtains a logical temperature variation T_Cal for compensating for the error wavelength Δλ (step S17). This calculation is carried out using the following formula (2):

$$T\_Cal = \frac{Δ λ}{Δ tWstd} \qquad ( 2 )$$

In this formula, ΔtWstd represents the temperature wavelength coefficient.

The measurement controlling computer 120 next adds the logical temperature variation T_Cal to the current temperature (the initial temperature T1 in this stage), and calculates a next setting temperature T_Set (step S18). The measurement controlling computer 120 then determines whether the setting temperature T_Set is within the temperature variable range (step S19). Here, the temperature variable range is a range defined in accordance with the standard, which is the same as for the power variable range.

If the setting temperature T_Set is not within the temperature variable range (“No” in step S19), the measurement controlling computer 120 determines that the LD module 11 is defective (step S25), and ends the operation. Here, the measurement controlling computer 120 preferably stores the identification number of the LD module 11 and the determination result (i.e., the LD module 11 being defective) in a predetermined file.

Meanwhile, if the setting temperature T_Set is within the temperature variable range (“Yes” in step S19), the measurement controlling computer 120 sets the setting temperature T_Set, calculated in step S18, in the laser temperature control monitoring device 103 (step S20), and causes the laser temperature control monitoring device 103 to start ATC control based on the setting temperature T_Set (step S21).

The measurement controlling computer 120 next measures the wavelength λ_act of the actual output light after the tuning at the setting temperature T_Set, based on measured values inputted from the wavelength current monitoring power source 101 and the light wavelength measuring device 104 (step S22). Hereinafter, the wavelength λ_act will be referred to as the actual measured wavelength λ_act. The measurement controlling computer 120 then calculates the error wavelength Δλ between the actual measured wavelength λ_act and the target wavelength λ_targ (step S23). The calculation of the error wavelength Δλ is carried out using the following formula (3):

Δλ=λ_targ−λ_act (3)

After calculating the post-tuning error wavelength Δλ in the above manner, the measurement controlling computer 120 determines whether the error wavelength Δλ is within an allowable range (step S24). If the error wavelength Δλ is within the allowable range, the measurement controlling computer 120 moves on to step S26. If not, the measurement controlling computer 120 returns to step S17, and repeats the above procedures so that the error wavelength Δλ falls within the allowable range. In the flowchart shown in FIG. 2, the procedures of steps S15 through S24 are referred to as the wavelength tuning routine 1.

In step S26, the measurement controlling computer 120 generates setting values based on the temperature and the other characteristics after tuning the actual measured wavelength λ_act into the error range of the target wavelength λ_targ. In step S27, the measurement controlling computer 120 relates the setting values to the identification number of the LD module 11, and then stores the setting values in a predetermined file.

The measurement controlling computer 120 then determines whether there is an untuned target wavelength λ_targ existing in the same wavelength locker module (step S28). If there is an untuned target wavelength λ_targ (“Yes” in step S28), the measurement controlling computer 120 sets the untuned target wavelength λ_targ as the next object (step S29). The measurement controlling computer 120 then returns to step S15, and repeats the above procedures to determine setting values to be stored in a predetermined file. If an untuned target wavelength λ_targ does not exist (“No” in step S28), the measurement controlling computer 120 ends the operation.

Through the above procedures, the setting values represented by the controlling point shown in FIG. 3A are determined. At the controlling point, the function λ_CONST for maintaining the target wavelength λ_targ crosses the center point P Cent of the power variable range, as shown in FIG. 3A.

As shown in FIG. 3A, the conventional technique can determine the setting values, as long as the controlling point determined through the above procedures is located within the temperature variable range. On the other hand, if the controlling point is not located within the temperature variable range, as shown in FIG. 3B, the setting values cannot be determined. Therefore, any LD module having a controlling point outside the temperature variable range has been considered to be defective, and not been employed as an optical component.

However, even if the controlling point is not located within the temperature variable range, the function λ_CONST for maintaining the target wavelength λ_targ may cross the region in which the power variable range and the temperature variable range overlap each other. In this case, the LD module is still considered to be defective, resulting in a low LD module yield.

### SUMMARY OF THE INVENTION

It is therefore an object of the present invention to provide an optical communication module and a wavelength locker module in which the above disadvantage is eliminated.

A more specific object of the present invention is to provide an optical communication module and a wavelength locker module that can prevent yield decrease.

Another specific object of the present invention is to provide a setting value acquiring device and method for realizing the above optical communication module and the wavelength locker module.

Yet another specific object of the present invention is to provide a program product for acquiring setting values and a recording medium on which the program is recorded.

The above objects of the present invention are achieved by an optical communication module that emits laser light having a wavelength depending on temperature and power intensity, comprising:

a laser light emitting unit that emits the laser light;

a temperature control unit that controls the temperature of the laser light emitting unit;

a power intensity control unit that controls the power intensity of the laser light emitted from the laser light emitting unit; and

a setting value storage unit that stores a setting value determined from an optimum power intensity that maintains a predetermined wavelength and satisfies predetermined temperature conditions and predetermined power intensity conditions, and from an optimum temperature that maintains the predetermined wavelength and satisfies the predetermined temperature conditions and the predetermined power intensity conditions;

the temperature control unit and the power intensity control unit controlling the temperature and the power intensity of the laser light emitting unit, based on the setting value stored in the setting value storage unit.

The above objects of the present invention are also achieved by a wavelength locker module that causes laser light emitted from a laser module to maintain a predetermined wavelength, comprising:

a temperature control unit that controls the temperature of the laser module;

a power intensity control unit that controls the power intensity of the laser light emitted from the laser module; and

a setting value storage unit that stores a setting value determined from an optimum power intensity that maintains the predetermined wavelength and satisfy predetermined temperature conditions and predetermined power intensity conditions, and from an optimum temperature that maintains the predetermined wavelength and satisfy the predetermined temperature conditions and the predetermined power intensity conditions,

the temperature control unit and the power intensity control unit controlling the temperature and the power intensity of the laser module, based on the setting value stored in the setting value storage unit, to thereby cause the laser light to maintain the predetermined wavelength.

The above objects of the present invention are also achieved by a setting value generating device that generates such a setting value that causes laser light emitted from a laser module to have a predetermined wavelength and satisfies predetermined temperature conditions and predetermined power intensity conditions, the setting value generating device comprising:

an optimum power intensity calculating unit that calculates an optimum power intensity that maintains the predetermined wavelength and satisfies the predetermined temperature conditions and the predetermined power intensity conditions;

an optimum temperature calculating unit that calculates an optimum temperature that maintains the predetermined wavelength and satisfies the predetermined temperature conditions and the predetermined power intensity conditions; and

a setting value generating unit that generates the setting value based on the optimum power intensity calculated by the optimum power intensity calculating unit and the optimum temperature calculated by the optimum temperature calculating unit.

The above objects of the present invention are also achieved by a method of generating a setting value in an information processing device that generates such a setting value that causes laser light emitted from a laser module to have a predetermined wavelength, and satisfies predetermined temperature conditions and predetermined power intensity conditions,

the method comprising the steps of:

calculating an optimum power intensity that maintains the predetermined wavelength and satisfies the predetermined temperature conditions and the predetermined power intensity conditions;

calculating an optimum temperature that maintains the predetermined wavelength and satisfies the predetermined temperature conditions and the predetermined power intensity conditions; and

generating the setting value based on the optimum power intensity and the optimum temperature calculated in the foregoing steps.

The above objects of the present invention are also achieved by a program product for causing a computer to generate such a setting value that causes laser light emitted from a laser module to have a predetermined wavelength and satisfies predetermined temperature conditions and predetermined power intensity conditions,

the program product comprising:

instructions for calculating an optimum power intensity that maintains the predetermined wavelength and satisfies the predetermined temperature conditions and the predetermined power intensity conditions;

instructions for calculating an optimum temperature that maintains the predetermined wavelength and satisfies the predetermined temperature conditions and the predetermined power intensity conditions; and

instructions for generating the setting value based on the optimum power intensity calculated in accordance with the optimum power intensity calculating instructions, and the optimum temperature calculated in accordance with the optimum temperature calculating instructions.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram illustrating the structure of a measuring system used to generate setting values for an LD module through a known wavelength tuning process;

FIG. 2 is a flowchart of an operation to be performed by the measurement controlling computer shown in FIG. 1;

FIGS. 3A and 3B illustrate setting values to be determined in accordance with the flowchart of FIG. 2;

FIGS. 4A and 4B illustrate setting values to be determined in accordance with the present invention;

FIG. 5 is a block diagram illustrating the structure of a measuring system used to generate setting values for an LD module through wavelength tuning procedures in accordance with a first embodiment of the present invention;

FIG. 6 is the first part of a flowchart of an operation to be performed by the measurement controlling computer shown in FIG. 5;

FIG. 7 is the second part of the flowchart of the operation to be performed by the measurement controlling computer shown in FIG. 5;

FIG. 8 is the third part of the flowchart of the operation to be performed by the measurement controlling computer shown in FIG. 5;

FIG. 9 is the fourth part of the flowchart of the operation to be performed by the measurement controlling computer shown in FIG. 5;

FIGS. 10A through 10E illustrate setting values to be determined through the procedures in accordance with the flowcharts of FIG. 2 and FIGS. 6 through 9;

FIG. 11 is a block diagram illustrating the structure of an optical communication module for multi-wave laser output in accordance with the first embodiment of the present invention;

FIGS. 12A and 12B illustrate the principles of a second embodiment of the present invention;

FIG. 13 illustrates setting values to be determined in accordance with the second embodiment of the present invention;

FIG. 14 is the first part of a flowchart of an operation to be performed by the measurement controlling computer in accordance with the second embodiment of the present invention;

FIG. 15 is the second part of the flowchart of the operation to be performed by the measurement controlling computer in accordance with the second embodiment of the present invention;

FIG. 16 illustrates the principles of a third embodiment of the present invention;

FIG. 17 illustrates setting values to be determined in accordance with the third embodiment of the present invention;

FIG. 18 is the first part of a flowchart of an operation to be performed by the measurement controlling computer in accordance with the third embodiment of the present invention;

FIG. 19 is the second part of the flowchart of the operation to be performed by the measurement controlling computer in accordance with the third embodiment of the present invention;

FIG. 20 is the third part of the flowchart of the operation to be performed by the measurement controlling computer in accordance with the third embodiment of the present invention;

FIG. 21 is the fourth part of the flowchart of the operation to be performed by the measurement controlling computer in accordance with the third embodiment of the present invention;

FIG. 22 is the fifth part of the flowchart of the operation to be performed by the measurement controlling computer in accordance with the third embodiment of the present invention;

FIG. 23 is the sixth part of the flowchart of the operation to be performed by the measurement controlling computer in accordance with the third embodiment of the present invention; and

FIG. 24 is the seventh part of the flowchart of the operation to be performed by the measurement controlling computer in accordance with the third embodiment of the present invention.

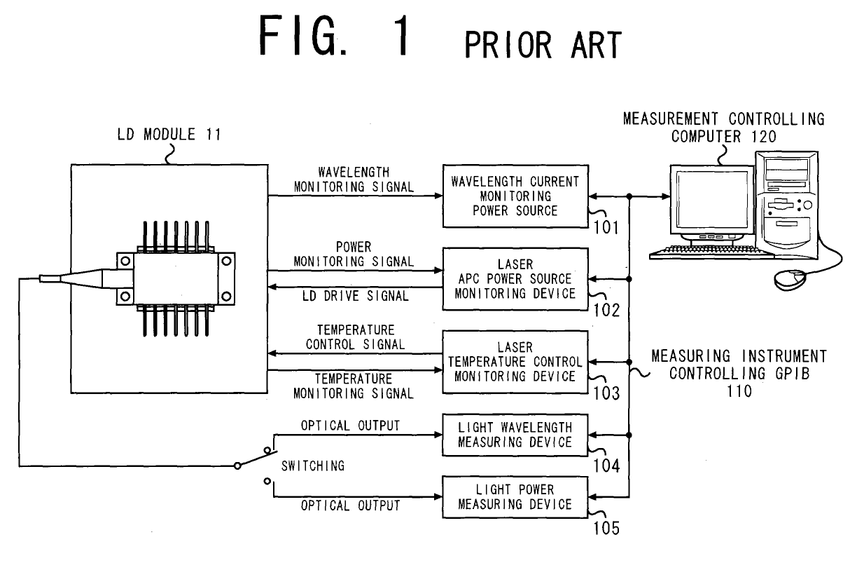

### DESCRIPTION OF THE PREFERRED EMBODIMENTS

(Principles)

The following is a description of the principles of the present invention, followed by explanation of preferred embodiments.

The present invention is aimed at preventing yield decrease in optical communication modules, including laser modules, by determining setting values that satisfy both the power variable range and the temperature variable range.

To achieve this, the present invention is to control the temperature and power intensity of each laser module based on setting values determined from the temperature dependency and the power intensity dependency of the laser module.

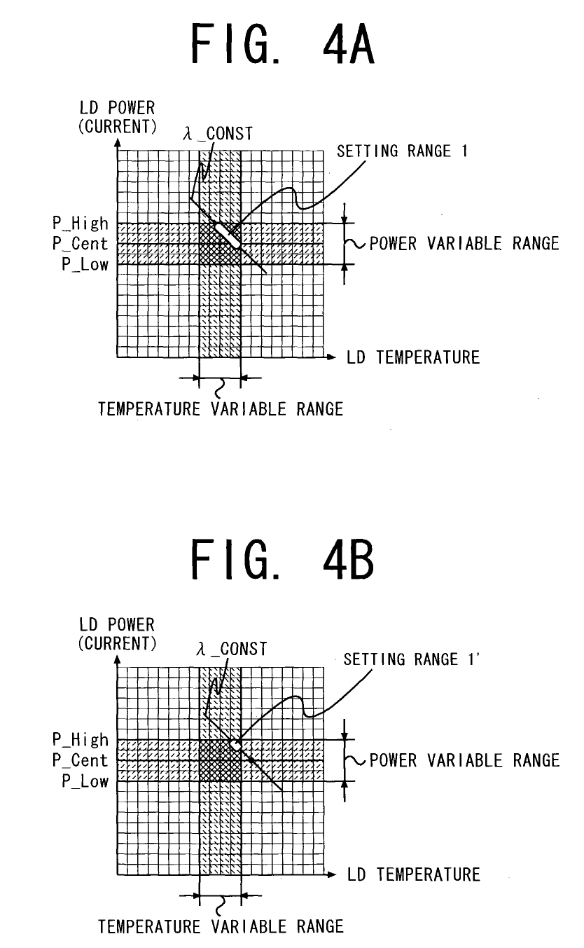

Accordingly, the control range of a laser module is not represented by a point, but by a segment (a setting range), as shown in FIG. 4A. In accordance with the present invention, setting values can be generated even if the center point P_Cent and the function λ_CONST do not cross within the temperature variable range, as shown in FIG. 4B.

Also, in accordance with the present invention, setting values are determined so that a laser module can be controlled at the center of a range that maintains a predetermined wavelength and satisfies predetermined temperature conditions and predetermined power intensity conditions. Thus, the present invention can maximize the reliability of the laser module and the optical communication module including the laser module.

The following is a description of embodiments of the present invention, with reference to the accompanying drawings.

(First Embodiment)

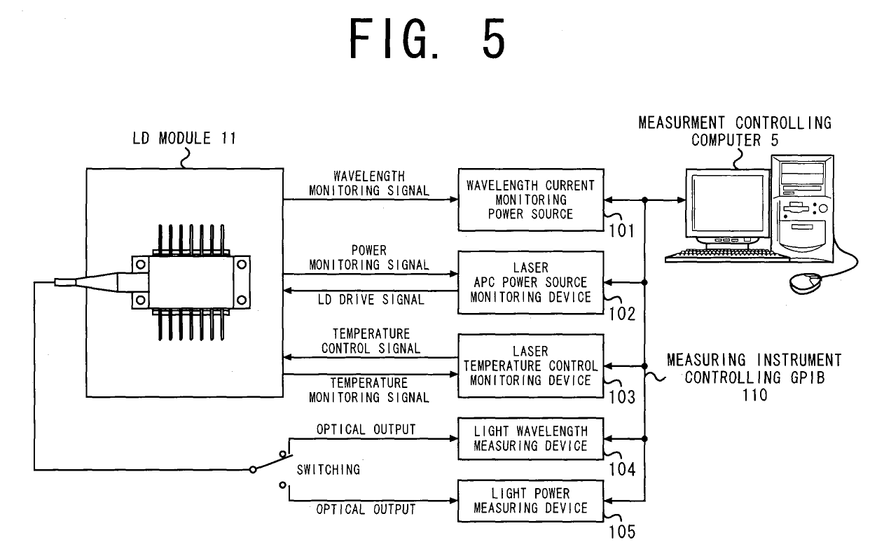

FIG. 5 is a block diagram illustrating the structure of a measuring system that is used to generate setting values for driving an LD module 11 (a laser module, equivalent to the laser light emitting unit in the claims) through a light wavelength tuning process in accordance with a first embodiment of the present invention.

As shown in FIG. 5, this measuring system includes the LD module 11, a wavelength current monitoring power source 101, a laser APC power source monitoring device 102, a laser temperature control monitoring device 103, and a measurement controlling computer 5.

In this structure, the wavelength current monitoring power source 101 receives a wavelength monitoring signal from a wavelength monitoring photodetector provided in the LD module 11, and measures the relative value of the wavelength of emitted laser light. Here, the wavelength monitoring signal is a wavelength intensity signal. The measured value is then inputted into the measurement controlling computer 5 via a measuring instrument controlling GPIB 110. This measurement controlling computer 5 functions as an information processing device to generate setting values.

The laser APC power source monitoring device 102 receives a power monitoring signal from a power monitoring photodetector provided in the LD module 11, and measures the relative value of the power of emitted laser light. The measured value is inputted into the measurement controlling computer 5 via the measuring instrument controlling GPIB 110. The laser APC power source monitoring device 102 also outputs an LD drive signal in accordance with an instruction inputted from the measurement controlling computer 5, and thereby controls the power of laser light emitted from the LD module 11.

The laser temperature control monitoring device 103 receives a temperature monitoring signal from a temperature sensor (such as a thermistor) provided in the LD module 11, and measures the temperature of the LD module 11, especially the temperature of the vicinity of the laser chip. The measured value is inputted into the measurement control computer 5 via the measuring instrument controlling GPIB 110. The laser temperature control monitoring device 103 also outputs a temperature control signal to a cooling/heating device (such as a Peltier device) provided in the LD module 11, in accordance with an instruction inputted from the measurement controlling computer 5, and thereby controls the temperature of the LD module 11, especially the temperature of the vicinity of the laser chip.

However, the wavelength and the power detected by the photodetectors provided in the LD module 11 shifts from the actual values, as the temperature of the LD module 11 fluctuates. Therefore, the measuring system shown in FIG. 5 further includes a light wavelength measuring device 104 and a light power measuring device 105 for measuring the wavelength and power of laser light emitted from the LD module 11.

The light wavelength measuring device 104 receives laser light emitted from the LD module 11, and measures the light wavelength of the laser light. This measurement is carried out based on the number of interference fringes formed by a combined wavelength of inputted laser light and reference light, for example. The light power measuring device 105 includes a photodetector that receives laser light emitted from the LD module 11 and measures the power of the emitted laser light. The measured value is then inputted into the measurement controlling computer 5 via the measuring instrument controlling GPIB 110.

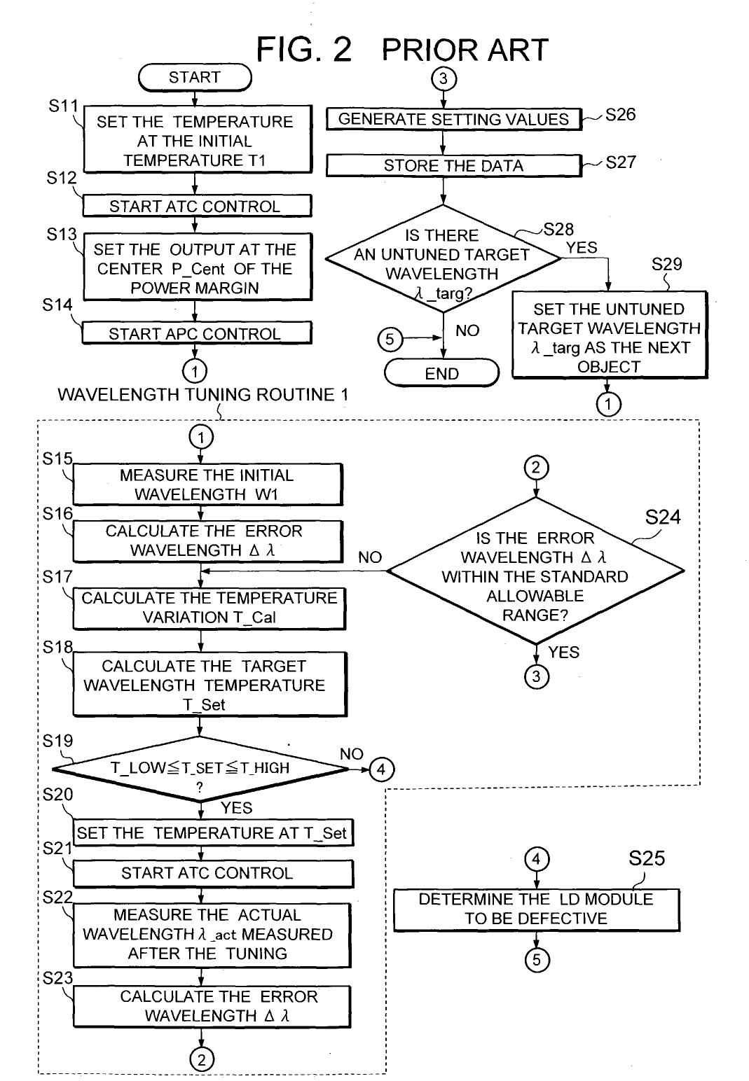

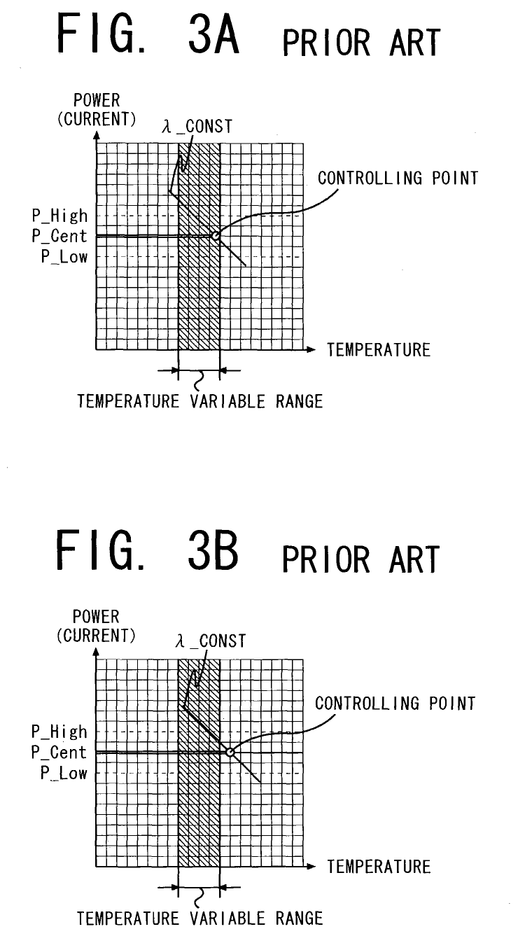

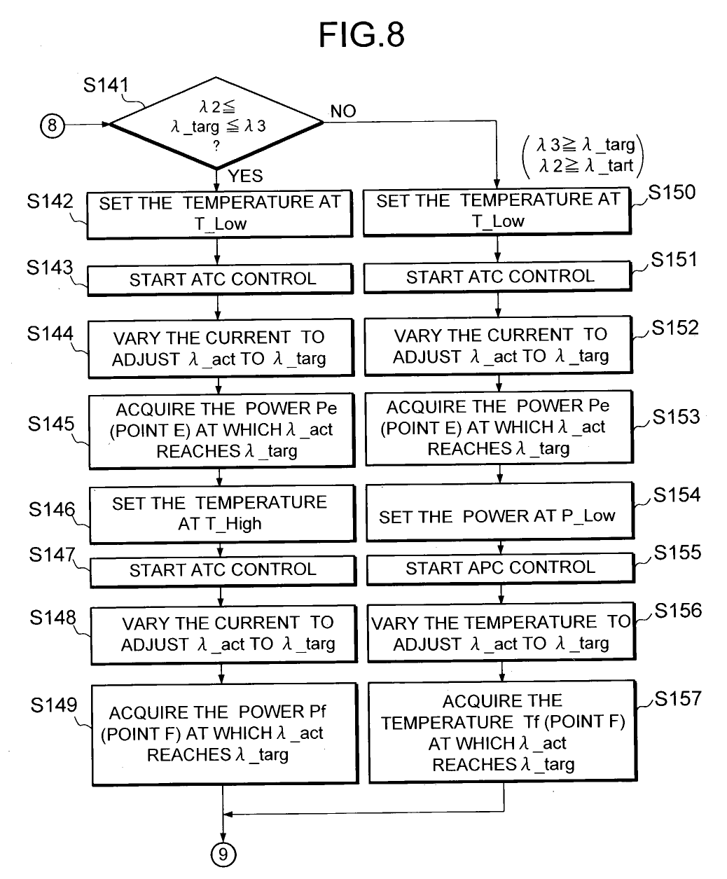

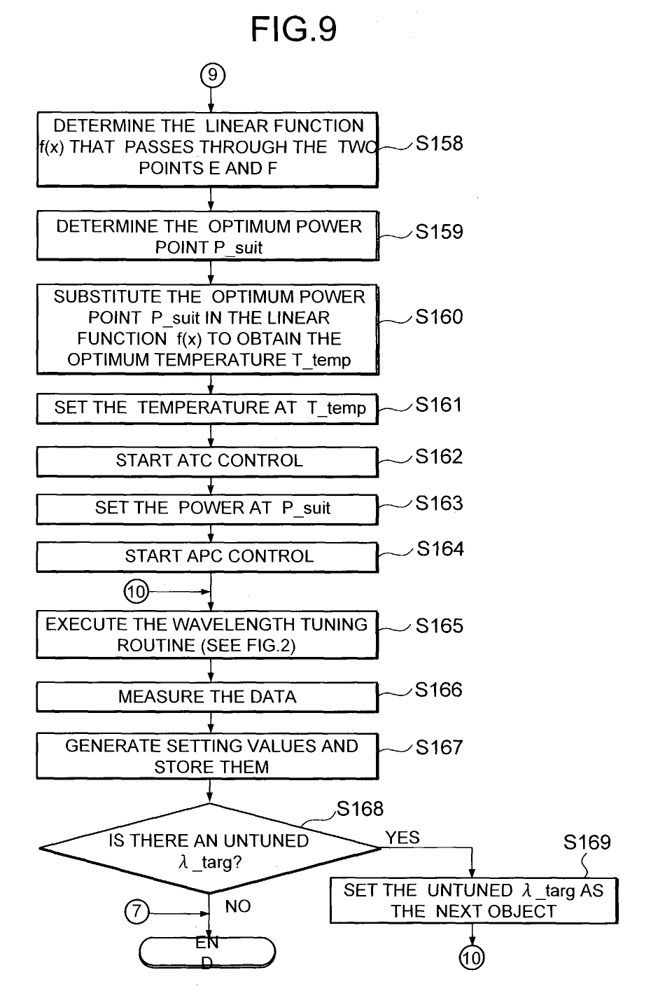

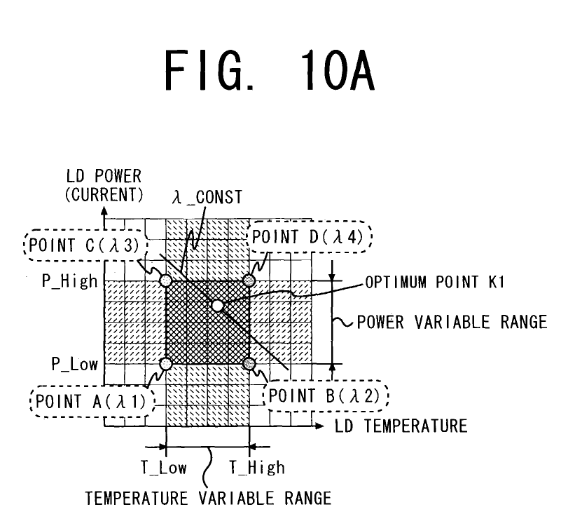

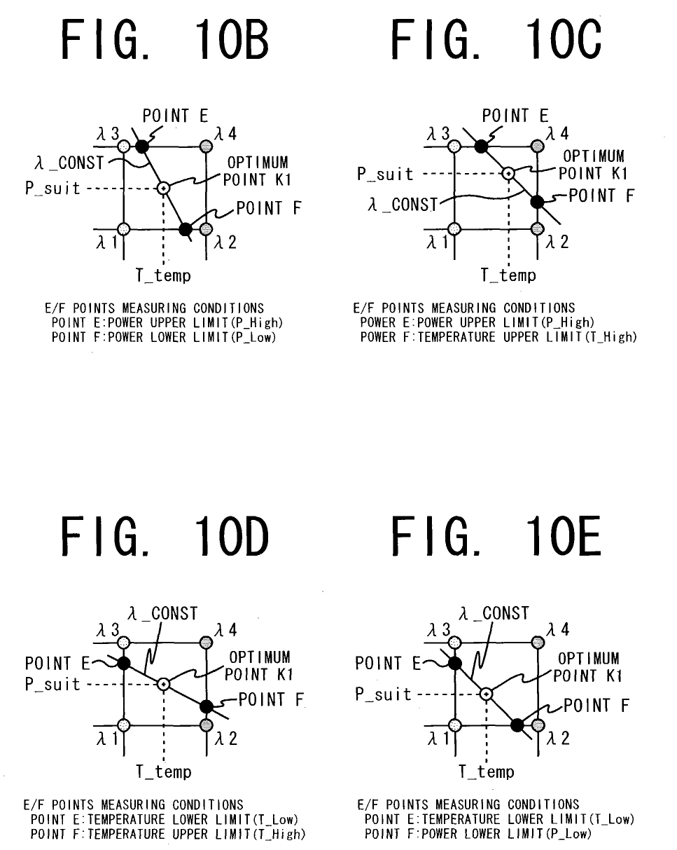

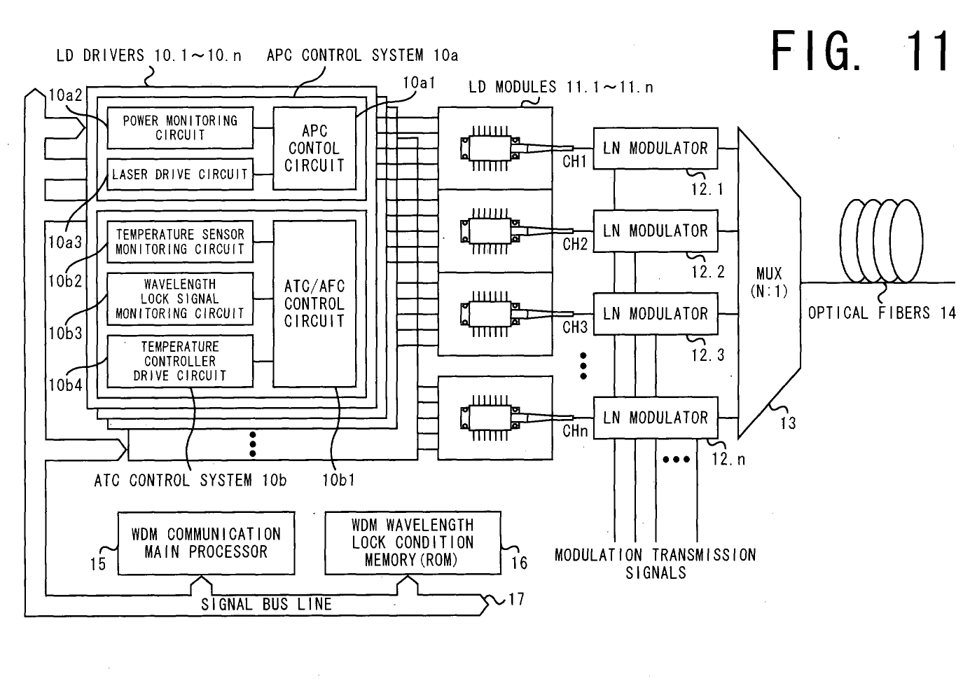

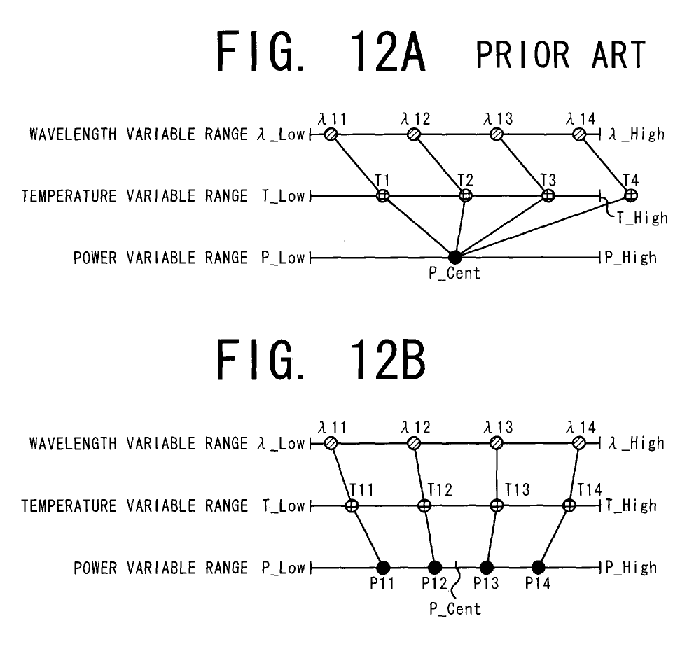

Next, the procedures to be carried out by the measurement controlling computer 5 to generate setting values in accordance with this embodiment will be described in detail, with reference to the flowcharts of FIG. 2 and FIGS. 6 through 9, as well as FIGS. 10A through 10E.

The measurement controlling computer 5 first sets a lowest variable temperature value T_Low in the laser temperature control monitoring device 103 (step S101), and causes the laser temperature control monitoring device 103 to start ATC control based on the lowest variable temperature (step S102). The measurement controlling computer 5 also sets a lowest variable power (power margin) value P_Low in the laser APC power source monitoring device 102 (step S103), and causes the laser APC power source monitoring device 102 to start APC control based on the lowest variable power (step S104). Based on the measured values inputted from the wavelength current monitoring power source 101 and the light wavelength measuring device 104, the measurement controlling computer 5 then measures the wavelength λ1 of actually emitted light (step S105). In this manner, the lowest variable temperature value T_Low and the lowest variable power value P_Low are set, and the wavelength at those values are measured. Thus, the wavelength λ1 at the point A in FIG. 10A can be measured. In other words, the wavelength under such conditions that minimize the wavelength can be measured. The procedures of steps S101 through S105 will be hereinafter referred to as the point-A wavelength-λ1 measuring routine.

The measurement controlling computer 5 next sets a highest variable temperature value T_High in the laser temperature control monitoring device 103 (step S106), and causes the laser temperature control monitoring device 103 to start ATC control based on the highest variable temperature (step S107). The measurement controlling computer 5 also sets the lowest variable power value P_Low in the laser APC power source monitoring device 102 (step S108), and causes the laser APC power source monitoring device 102 to start APC control based on the lowest variable power (step S109). After that, the measurement controlling computer 5 measures the wavelength λ2 of the actually emitted light, based on the measured values inputted from the wavelength current monitoring power source 101 and the light wavelength measuring device 104 (step S110). In this manner, the highest variable temperature value T_High and the lowest variable power value P_Low are set, and the wavelength at those values is measured. Thus, the wavelength λ2 at the point B in FIG. 10B can be measured. The procedures of steps S106 through S110 will be hereinafter referred to as the point-B wavelength-λ2 measuring routine. However, as the power to be set in this routine is the same as that in the previous routine, steps S108 and S109 may be skipped.

The measurement controlling computer 5 next sets the lowest variable temperature value T_Low in the laser temperature control monitoring device 103 (step S11), and causes the laser temperature control monitoring device 103 to start ATC control based on the lowest variable temperature (step S112). The measurement controlling computer 5 also sets a highest variable power value P_High in the laser APC power source monitoring device 102 (step S113), and causes the laser APC power source monitoring device 102 to start APC control based on the lowest variable power (step S114) After that, the measurement controlling computer 5 measures the wavelength λ3 of the actually emitted light, based on the measured values inputted from the wavelength current monitoring power source 101 and the light wavelength measuring device 104 (step S115). In this manner, the lowest variable temperature value T_Low and the highest variable power value P_High are set, and the wavelength at those values is measured. Thus, the wavelength λ3 at the point C in FIG. 10A can be measured. The procedures of steps S111 through S115 will be hereinafter referred to as the point-C wavelength-λ3 measuring routine.

The measurement controlling computer 5 further sets the highest variable temperature value T_High in the laser temperature control monitoring device 103 (step S116), and causes the laser temperature control monitoring device 103 to start ATC control based on the highest variable temperature (step S117). The measurement controlling computer 5 also sets the highest variable power value P_High in the laser APC power source monitoring device 102 (step S118), and causes the laser APC power source monitoring device 102 to start APC control based on the highest variable power (step S119). After that, the measurement controlling computer 5 measures the wavelength λ4 of the actually emitted light, based on the measured values inputted from the wavelength current monitoring power source 101 and the light wavelength measuring device 104 (step S120). In this manner, the highest variable temperature value T_High and the highest variable power value P_High are set, and the wavelength at those values is measured. Thus, the wavelength λ4 at the point D in FIG. 10A can be measured. In other words, the wavelength under such conditions that maximize the wavelength can be measured. The procedures of steps S116 through S120 will be hereinafter referred to as the point-D wavelength-λ4 measuring routine. However, the power to be set in this routine is the same as that in the previous routine, steps S118 and S119 may be skipped.

After measuring the wavelengths at the points A, B, C, and D in FIG. 10A in the above manner, the measurement controlling computer 5 determines whether a target wavelength λ_targ is within the range of wavelength λ1 to the wavelength λ4 (step S121). By doing so, the measurement controlling computer 5 determines whether the setting values for the LD module 11 can be obtained in accordance with this embodiment. If the target wavelength λ_targ is not within the range of λ1 to λ4 (“No” in step S121), the measurement controlling computer 5 determines that the LD module 11 is defective (step S122), and ends the operation.

If the target wavelength λ_targ is within the range of λ1 to λ4 (“Yes” in step S121), the measurement controlling computer 5 determines whether the target wavelength λ_targ is within the range of λ3 to λ2 (step S123). By doing so, the measurement controlling computer 5 determines whether the function λ_CONST for maintaining the target wavelength λ_targ crosses the boundary lines of the region in which the temperature variable range and the power variable range overlap each other, as shown in FIG. 10B.

If the target wavelength λ_targ is within the range of λ3 to λ2 (“Yes” in step S123), the measurement controlling computer 5 sets the highest variable power value P_High in the laser APC power source monitoring device 102 (step S124), and causes the laser APC power source monitoring device 102 to start APC control based on the highest variable power (step S125). After that, measurement controlling computer 5 varies the temperature under the APC control, so that the actual measured wavelength λ_act becomes equal to the target wavelength λ_targ (step S126). The measurement controlling computer 5 then acquires the temperature Te at which the actual measured wavelength λ_act reaches the target wavelength λ_targ (step S127). Through these procedures, the measurement controlling computer 5 acquires the power P_High and the temperature Te at the point E in FIG. 10B.

The measurement controlling computer 5 next sets the power at P_Low (step S128), and causes the laser APC power source monitoring device 102 to start APC control based on the power P_Low (step S129). The measurement controlling computer 5 then varies the temperature under the APC control, so that the actual measured wavelength λ_act becomes equal to the target wavelength ?_targ (step S130). The measurement controlling computer 5 acquires the temperature Tf at which the actual measured wavelength λ_act reaches the target wavelength λ_targ (step S131). Through these procedures, the measurement controlling computer 5 acquires the power P_Low and the temperature Tf at the point F in FIG. 10B.

In the above manner, the two points E and F at which the function λ_CONST for maintaining the target wavelength λ_targ crosses the boundary lines of the region in which the temperature variable range and the power variable range overlap each other, as shown in FIG. 10B, can be determined.

Meanwhile, if the target wavelength λ_targ is not within the range of λ3 to λ2 (“No” in step S123), the measurement controlling computer 5 determines whether the target wavelength λ_targ is longer than both λ3 and λ2 (step S132). By doing so, the measurement controlling computer 5 determines whether the function λ_CONST for maintaining the target wavelength λ_targ crosses the boundary lines of the region in which the temperature variable range and the power variable range overlap each other, as shown in FIG. 10C.

If the target wavelength λ_targ is longer than both λ3 and λ2 (“Yes” in step S132), the measurement controlling computer 5 sets the highest variable power value P_High in the laser APC power source monitoring device 102 (step S133), and causes the laser APC power source monitoring device 102 to start APC control based on the highest variable power (step S134). After that, the measurement controlling computer 5 varies the temperature under the APC control, so that the actual measured wavelength A act becomes equal to the target wavelength λ_targ (step S135). The measurement controlling computer 5 then acquires the temperature Te at which the actual measured wavelength A act reaches the target wavelength λ_targ (step S136). Through these procedures, the measurement controlling computer 5 acquires the power (P_High) and the temperature Te at the point E in FIG. 10C.

The measurement controlling computer 5 next sets the temperature at T_High (step S137), and causes the laser temperature control monitoring device 103 to starts ATC control based on the temperature T High (step S138). After that, the measurement controlling computer 5 varies the drive current of the LD module 11 under the ATC control, so that the actual measured wavelength λ_act becomes equal to the target wavelength λ_targ (step S139). The measurement controlling computer 5 then acquires the power Pf at which the actual measured value λ act reaches the target wavelength λ_targ (step S140). Through these procedures, the measurement controlling computer 5 acquires the power Pf and the temperature T_High at the point F in FIG. 10C.

In the above manner, the two points E and F at which the function λ_CONST for maintaining the target wavelength λ_targ crosses the boundary lines of the region in which the temperature variable range and the power variable range overlap each other, as shown in FIG. 10C, can be determined.

Meanwhile, if the target wavelength λ_targ is not longer than both λ3 and λ2 (“No” in step S132), the measurement controlling computer 5 determines whether the target wavelength λ_targ is within the range of λ2 to λ3 (step S141). By doing so, the measurement controlling computer 5 determines whether the function λ_CONST for maintaining the target wavelength λ_targ crosses the boundary lines of the region in which the temperature variable range and the power variable range overlap each other, as shown in FIG. 10D.

If the target wavelength λ_targ is within the range of λ2 to λ3 (“Yes” in step S141), the measurement controlling computer 5 sets the lowest variable temperature value T_Low in the laser temperature control monitoring device 103 (step S142), and causes the laser temperature control monitoring device 103 to start ATC control based on the lowest variable temperature (step S143). After that, the measurement controlling computer 5 varies the drive current of the LD module 11 under the ATC control, so that the actual measured wavelength λ_act becomes equal to the target wavelength λ_targ (step S144). The measurement controlling computer 5 then acquires the power Pe with which the actual measured wavelength λ_act reaches the target wavelength λ_targ (step S145). Through these procedures, the measurement controlling computer 5 acquires the power Pe and the temperature T_Low at the point E in FIG. 10D.

The measurement controlling computer 5 next sets the temperature at T_High (step S146), and causes the laser temperature control monitoring device 103 to start ATC control based on the temperature T_High (step S147). After that, the measurement controlling computer 5 varies the drive current of the LD module 11 under the ATC control, so that the actual measured wavelength λ_act becomes equal to the target wavelength λ_targ (step S148). The measurement controlling computer 5 then acquires the power Pf with which the actual measured wavelength λ_act reaches the target wavelength λ_targ (step S149). Through these procedures, the measurement controlling computer 5 acquires the power Pf and the temperature T_High at the point F in FIG. 10D.

In the above manner, the two points E and F at which the function λ_CONST for maintaining the target wavelength λ_targ crosses the boundary lines of the region in which the temperature variable range and the power variable range overlap each other, as shown in FIG. 10D, are determined.

Meanwhile, if the target wavelength λ_targ is not within the range of λ2 to λ3 (“No” in step S141), it is considered that the target wavelength λ_targ is shorter than both λ3 and λ2, which is the only one remaining option here. Therefore, the measurement controlling computer 5 executes the following procedures, in which it is assumed that the function λ_CONST for maintaining the target wavelength λ_targ crosses the boundary lines of the region in which the temperature variable range and the power variable range overlap each other, as shown in FIG. 10E.

More specifically, the measurement controlling computer 5 sets the lowest variable temperature value T_Low in the laser temperature control monitoring device 103 (step S150), and causes the laser temperature control monitoring device 103 to start ATC control based on the temperature T_Low (step S151). After that, the measurement controlling computer 5 varies the drive current of the LD module 11 under the ATC control, so that the actual measured wavelength λ_act becomes equal to the target wavelength λ_targ (step S152). The measurement controlling computer 5 then acquires the power Pe at which the actual measured wavelength λ_act reaches the target wavelength λ_targ (step S153). Through these procedures, the measurement controlling computer 5 acquires the power Pe and the temperature T_Low at the point E in FIG. 10E.

The measurement controlling computer 5 next sets the power at P_Low (step S154), and causes the laser APC power source monitoring device 102 to start APC control based on the power P_Low (step S155). After that, the measurement controlling computer 5 varies the temperature under the APC control, so that the actual measured wavelength λ_act becomes equal to the target wavelength λ_targ (step S156). The measurement controlling computer 5 then acquires the temperature Tf at which the actual measured wavelength λ_act reaches the target wavelength λ_targ (step S157). Through these procedures, the measurement controlling computer 5 acquires the power P_Low and the temperature Tf at the point F in FIG. 10E.

In the above manner, the two points E and F at which the function λ_CONST for maintaining the target wavelength λ_targ crosses the boundary lines of the region in which the temperature variable range and the power variable range overlap each other, as shown in FIG. 10E, are determined.

It should be noted that the power at the point E in FIGS. 10A through 10E represents the upper limit of the power that can be a setting value for controlling the LD module 11 in this embodiment. Likewise, the temperature at the point E represents the lower limit of the temperature that can be a setting value. Also, the power at the point F represents the lower limit of the power that can be a setting value for controlling the LD module 11 in this embodiment. Likewise, the temperature at the point F represents the upper limit of the temperature that can be a setting value.

After determining the two points E and F through the above procedures, the measurement controlling computer 5 determines the line formula f(x) that passes through the two points E and F (step S158). The straight line represents the relational expression of λ_CONST. The procedure of step S158 realizes the means to define the relational expression.

The measurement controlling computer 5 also determines the optimum power (the power optimum point P_suit), based on the defined relational expression f(x), the temperature variable range, and the power variable range (step S159). More specifically, the measurement controlling computer 5 calculates the power upper limit value and the power lower limit value that satisfy the relational expression f(x), the temperature variable range, and the power variable range. The middle value between the upper limit value and the lower limit value is set as the power optimum point P_suit. In other words, the procedures of step S159 realize the means to calculate the power upper limit value and the power lower limit value, and the means to calculate the optimum power from the power upper limit value and the power lower limit value.

The measurement controlling computer 5 then substitutes the optimum power P suit in the function f(x), so as to determine the corresponding temperature (step S160). The corresponding temperature is an indication of the optimum temperature for tuning the wavelength to the target wavelength λ_targ, and is equivalent to the middle value of the temperature values at the two point E and F. In short, the procedure of step S160 realizes the means to calculate the optimum temperature. The temperature determined in step S160 will be hereinafter referred to as the optimum temperature T_temp.

After determining P suit and T temp in the above manner, the measurement controlling computer 5 sets the temperature at T_temp (step S161), and causes the laser temperature control monitoring device 103 to start ATC control based on the temperature T_temp (step S162). The measurement controlling computer 5 also sets the power at P_suit (step S163), and causes the laser APC power source monitoring device 102 to start APC control based on the power P_suit (step S164).

The measurement controlling computer 5 then executes the wavelength tuning routine 1 (see FIG. 2) (step S165), so as to tune the actual measured wavelength λ_act to the target wavelength λ_targ. Here, the initial wavelength W1 in step S15 of FIG. 2 is not the wavelength determined from the initial temperature T1 and the center point P_Cent of the power variable range, but is the wavelength determined from the power optimum point P suit and the optimum temperature T_temp calculated through the above procedures.

After tuning the light output of the LD module 11 into the error range of the target wavelength λ_targ, the measurement controlling computer 5 measures the actual power and temperature (which are the setting values) and the other characteristics of the laser light under the conditions (step S166). The measurement controlling computer 5 also generates setting values based on the measured data, and stores the setting values, which are related to the identification number of the LD module 11, in a predetermined file (step S167). Through these procedures of the wavelength tuning routine 1 to the data measurement and storing, the means to generate setting values and the means to store the setting values can be realized.

The measurement controlling computer 5 then determines whether an untuned target wavelength λ_targ exists in the same wavelength locker module (step S168). If there is an untuned target wavelength λ_targ (“Yes” in step S168), the measurement controlling computer 5 changes the measurement object to the next LD module 11 (step S169). The measurement controlling computer 5 then returns to step S101, and generates and stores setting values in a predetermined file through the same procedures as the above. If an untuned target wavelength λ_targ does not exist (“No” in step S168), the measurement controlling computer 5 ends the operation.

As described above, in accordance with this embodiment, values that satisfy both the power variable range and the temperature variable range are set as setting values, so that yield decrease of the optical communication module including LD modules can be prevented. Furthermore, the setting values are determined so as to maintain a predetermined wavelength, and are controlled at the center of a range that satisfy predetermined temperature conditions and power intensity conditions. Thus, the reliability of an LD module and the optical communication module containing the LD module can be increased to the maximum.

The above operation of the measurement controlling computer 5 can be realized through a program. Here, a general-purpose personal computer or the like may be used as the measurement controlling computer 5. This program may be recorded on a recording medium, such as a CD(Compact Disc)-ROM, a recordable/rewritable CD, a DVD (Digital Versatile Disc)-ROM, or recordable/rewritable DVD.

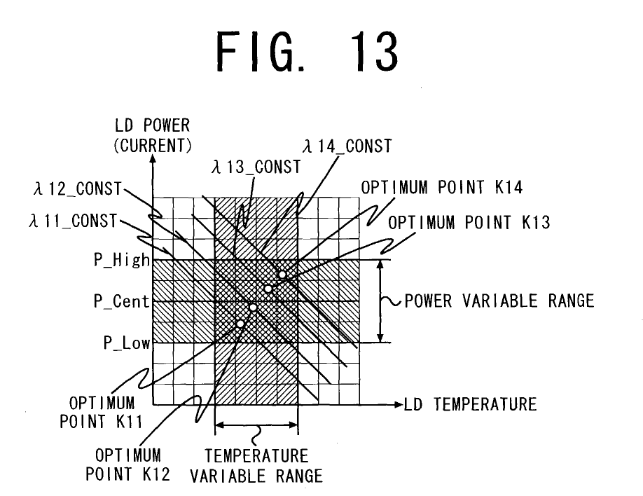

LD modules 11 having the setting values stored therein are incorporated into an optical communication module of multi-wave laser output, as shown in FIG. 11 (the LD modules 11 being denoted by 11.1 through 11.n). This optical communication module also includes LD drivers 10.1 through 10.n for driving the LD modules 11.1 through 11.n. The LD drivers 10.1 through 10.n are communicably connected to one another via a WDM (Wavelength Division Multiplexing) communication main processor 15, a WDM wavelength locking condition memory (ROM) 16, and a signal bus line 17. The WDM communication main processor 15 and the WDM wavelength locking condition memory 16 are internally or externally provided. In this structure, the LD drivers 10.1 through 10.n, the WDM communication main processor 15, the WDM wavelength locking condition memory 16, and the signal bus line 17, function as a wavelength locker module.

More specifically, the WDM communication main processor 15 reads the setting values from the WDM wavelength locking condition memory 15, which is a storage device for storing setting values. Based on the read setting values, the WDM communication main processor 15 controls the LD drivers 10.1 through 10.n. Hereinafter, any LD driver will be denoted by reference numeral 10, and any LD module will be denoted by reference numeral 11.

An LD driver 10 includes an APC control system 10a and an ATC control system 10b. The APC control system 10a is a power intensity controller for controlling the power intensity (power) of the LD module 11, and includes an APC control circuit 10a1, a power monitor circuit 10a2, and a laser drive circuit 10a3. The power monitor circuit 10a2 monitors the power of laser light, based on power monitoring signals inputted from the LD module 11. The APC control circuit 10a1 controls the laser drive circuit 10a3, based on the power corresponding to a setting value inputted from the WDM communication main processor 15 and a measured value inputted from the power monitor circuit 10a2 (the APC control circuit 10a1 is also referred to as a power intensity control circuit). The laser drive circuit 10a3 outputs an LD drive signal for driving the LD module 11 under the control of the APC control circuit 10a1.

The ATC control system 10b is a temperature controller for controlling the temperature of the LD module 11, and includes an ATC/AFC (Automatic Frequency Control) control circuit 10b1, a temperature sensor monitor circuit 10b2, a wavelength lock signal monitor circuit 10b3, and a temperature controller drive circuit 10b4. The ATC control system 10b also includes a function of controlling the wavelength of laser light emitted from the LD module 11 by virtue of temperature fluctuations. The temperature sensor monitor circuit 10b2 monitors the temperature of the LD module 11, based on temperature monitoring signals inputted from the LD module 11. The ATC control system 10b is also referred to as the temperature monitor circuit.

The wavelength lock signal monitor circuit 10b3 monitors the wavelength of laser light emitted from the LD module 11, based on wavelength monitoring signals inputted from the LD module 11.

The temperature controller drive circuit 10b4 drives the cooling/heating device in the LD module 11 under the control of the ATC/AFC control circuit 10b1, to thereby control the temperature of the LD module 11. The temperature controller drive circuit 10b4 is also referred to as the cooling/heating device drive circuit.

The ATC/AFC control circuit 10b1 controls the temperature controller drive circuit 10b4, based on the temperature corresponding to a setting value inputted from the WDM communication main processor 15, a measured value inputted from the temperature sensor monitor circuit 10b2, and/or a wavelength inputted from the wavelength lock signal monitor circuit 10b3. By doing so, the ATC/AFC control circuit 10b1 adjusts light emitted from the LD module 11 to the target wavelength. The ATC/AFC control circuit 10b1 is also referred to as the temperature control circuit.

Also, laser light emitted from the LD modules 11.1 through 11.n is subjected to predetermined modulation by LN modulators 12.1 through 12.n. The modulated light is multiplexed by an N:1 multiplexer (MUX) 13, and is then outputted to optical fibers 14 that are transmission media.

As described above, the setting values generated through the above procedures are stored in a memory that is internally or externally provided, and an LD module is driven based on the setting values. Thus, the optical communication module in accordance with this embodiment can operate based on the setting values that satisfy both the power variable range and the temperature variable range. The optical communication module that includes LD modules can maintain a predetermined wavelength and can be controlled at the center of a range that satisfy predetermined temperature conditions and predetermined power intensity conditions. Thus, the reliability of the LD modules and the operation of the optical communication module that includes the LD modules can be increased to the maximum.

(Second Embodiment)

In the above first embodiment, a defect check is performed every time when a target wavelength is reset. Conventionally, when one laser LD module emits laser light of varied wavelengths, the power for all the wavelengths is set at one point (the center power P_Cent). As a result, the setting temperature for a wavelength might exceed the temperature variable range (see the wavelength λ14 in FIG. 12A). In such a case, the LD module is conventionally determined to be defective. In this embodiment, however, this type of defect can be detected in advance.

This embodiment is also aimed at increasing the yield of each LD module. Therefore, this embodiment also adhere to the principles of the present invention, which is to control the temperature and the power intensity of each LD module based on setting values determined from the temperature dependency and the power intensity dependency of the LD module. As shown in FIG. 12B, the temperature and the power are combined for each wavelength, and the control is performed based on the combined value.

As shown in FIG. 13, in accordance with this embodiment, an optimum power and an optimum temperature are defined for each of the wavelengths of one LD module (see the optimum points K11 through K14 in FIG. 13). Here, setting values that satisfy both the power variable range and the temperature variable range are generated. Thus, yield decrease of the optical communication module including the wavelength-variable LD module can be prevented.

The structure of the measuring system used to generate the setting values for the LD module 11 of this embodiment is the same as the structure of the first embodiment shown in FIG. 5.

In the following, the operation of the measurement controlling computer 5 generating setting values in accordance with this embodiment will be described in detail, with reference to the accompanying drawings.

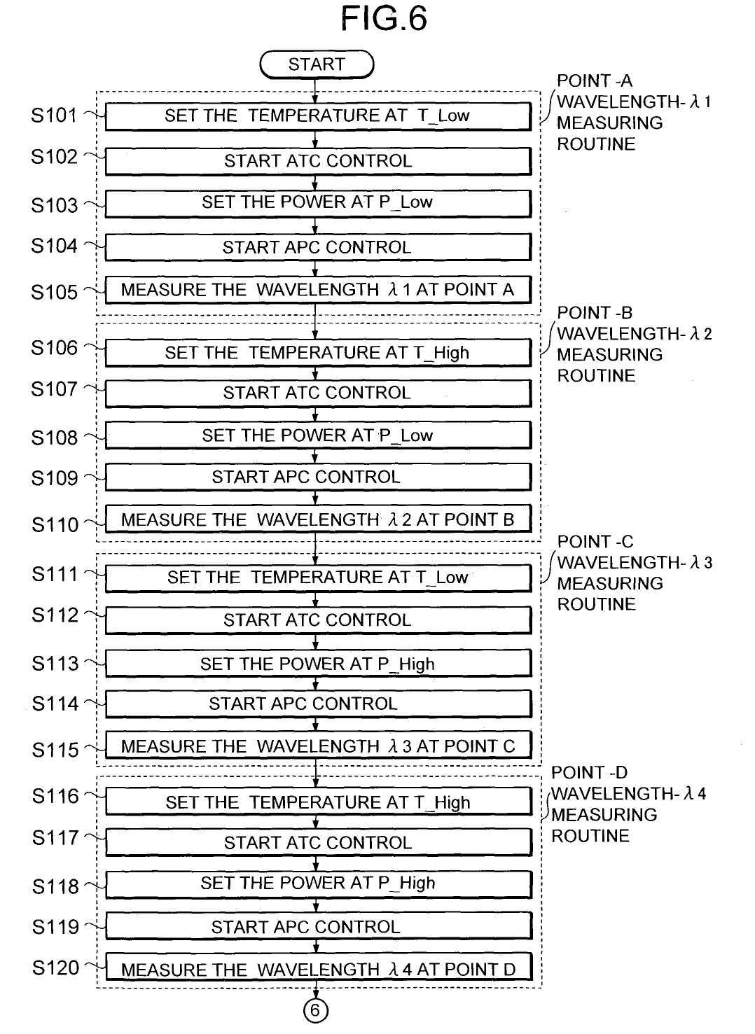

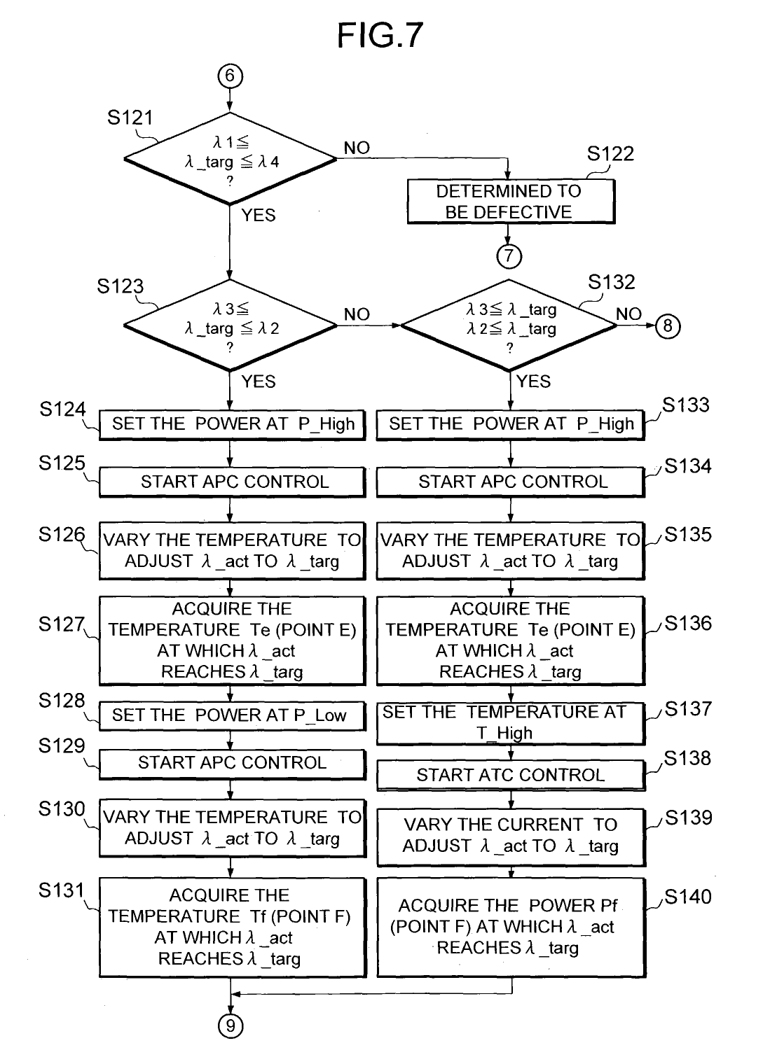

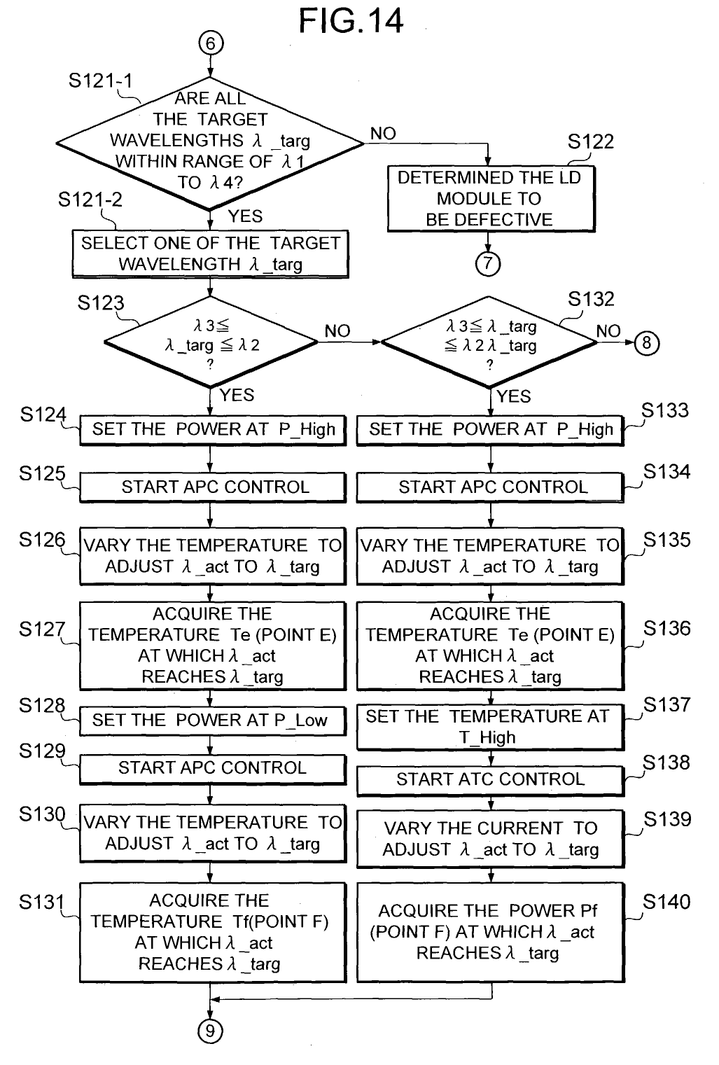

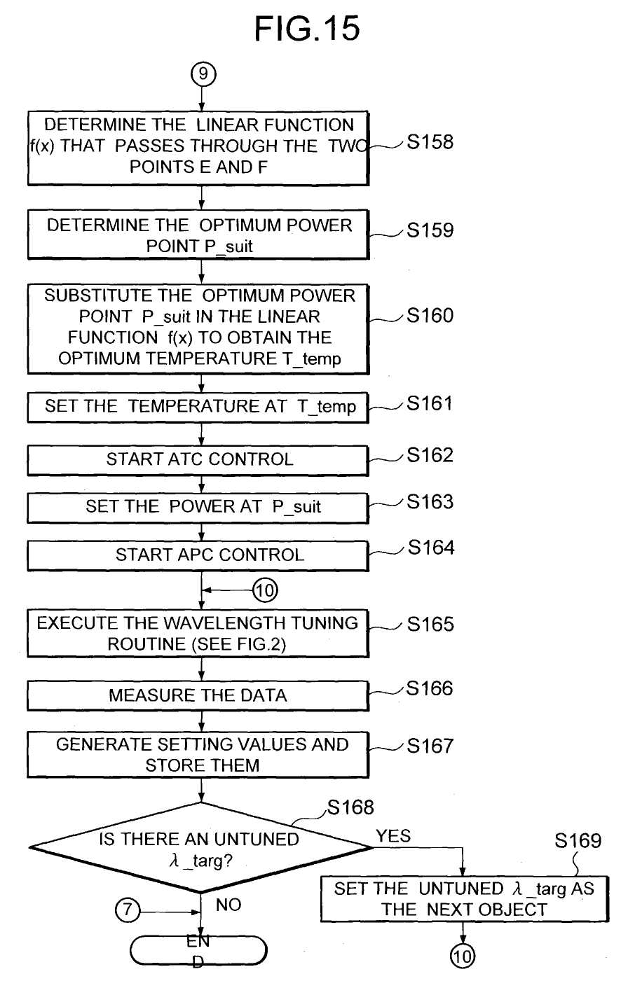

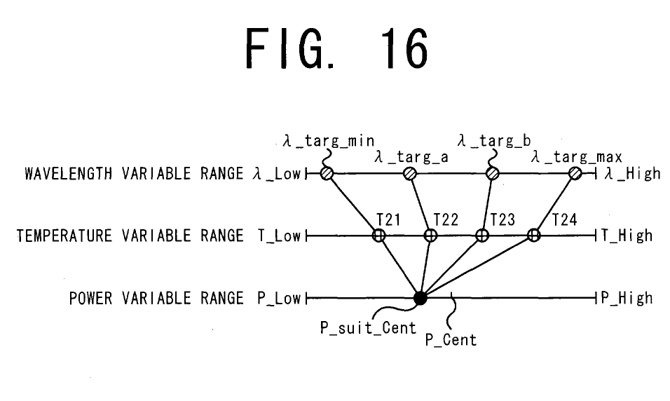

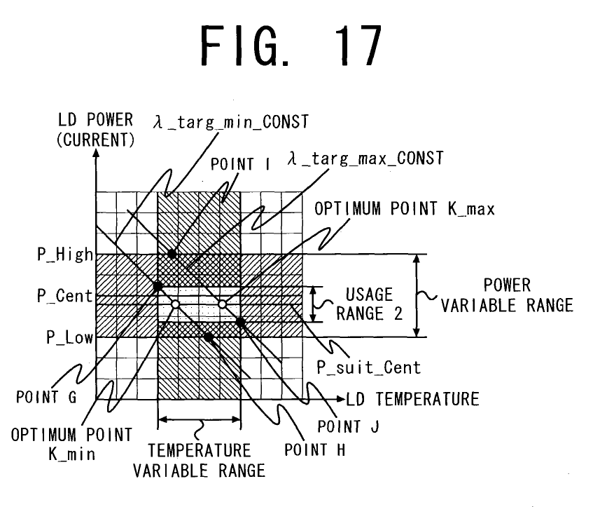

The fundamental operation of the measurement controlling computer 5 of this embodiment is substantially the same as the procedures in accordance with the first embodiment shown in FIGS. 6 through 9 (as well as a part of FIG. 2). However, step S121 in FIG. 7 should be replaced with step S121-1 in FIG. 14.

More specifically, after determining the wavelengths λ1 through λ4 at the points A through D through the series of procedures shown in FIG. 6, the measurement controlling computer 5 determines whether all the target wavelengths λ_targ (for example, λ11 through λ14, shown in FIG. 12B) of the LD module 11 are within the range of λ1 to λ4 (step S121-1). By doing so, the measurement controlling computer 5 determines whether setting values can be obtained for all of the wavelengths of the LD module 11. If not all the target wavelengths λ_targ are within the range of λ1 to λ4 (“No” in step S121-1), the measurement controlling computer 5 moves on to step S122 in which the LD module 11 is determined to be defective in the same manner as in the first embodiment. The operation then comes to end.

If all the target wavelengths λ_targ are within the range of λ1 to λ4 (“Yes” in step S121-1), the measurement controlling computer 5 selects one of the target wavelengths λ_targ (step S121-2). The measurement controlling computer 5 then moves on to step S123, and performs the rest of the operation for the selected λ_targ. After that, the measurement controlling computer 5 carries out the same procedures as those of the first embodiment.

In the above manner, setting values for causing the LD module 11 to emit laser light of varied wavelengths can be generated and stored. The setting values generated in this manner are stored in the WDM wavelength locking condition memory 16 shown in FIG. 11, for example. In this case, the LD modules 11.1 through 11.n function as the LD module that can have different wavelengths. The other parts of the structure are the same as those of the first embodiment, and therefore, explanation of them is omitted herein.

(Third Embodiment)

In addition to the first and second embodiments, another preferred embodiment to generate setting values for a wavelength-variable laser will be described in detail, with reference to the accompanying drawings.

In the second embodiment, different power setting values are set for the respective wavelengths. In this embodiment, on the other hand, the power setting values for wavelengths are put into one. More specifically, the power setting value for each of the wavelengths (λ_targ_min through λ_targ_max) is represented by one point (P_suit_Cent) within the power variable range, as shown in FIG. 16. Also, the switching of output wavelengths of the LD module is performed by varying temperatures.

When the one point with respect to the power is determined, the range in which the power variable range of the shortest target wavelength λ_targ_min and the power variable range of the longest target wavelength λ_targ_max overlap each other (equivalent to the usage range 2 shown in FIG. 17) is defined, and the center point of the range is set as the power optimum point (P_suit_Cent). The usage range 2 is determined from the power upper limit value of λ_targ_min CONST in the range in which the temperature variable range and the power variable range overlap each other, and the power lower limit value of λ_targ_max_CONST in the range in which the temperature variable range and the power variable range overlap each other. Here, λ_targ_min CONST represents the relational expression between the temperature and the power for maintaining the shortest target wavelength (the shortest target wavelength relational expression), while λ_targ_max_CONST represents the relational expression between the temperature and the power for maintaining the longest target wavelength (the longest target wavelength relational expression).

As the power optimum point P_suit_Cent is set collectively for various wavelengths, the LD module 11 can be controlled in a simpler manner with a smaller amount of data. Since the power optimum point P_suit_Cent can be set at any point in the power variable range, yield decrease of an optical communication module that includes the LD module 11 can be prevented.

The structure of the measuring system used to generate setting values for the LD module 11 in this embodiment is the same as that of the structure of the first embodiment shown in FIG. 5. However, the LD module 11 of this embodiment includes a laser light emitting unit that can vary wavelengths, instead of the laser light emitting unit of a single wavelength.

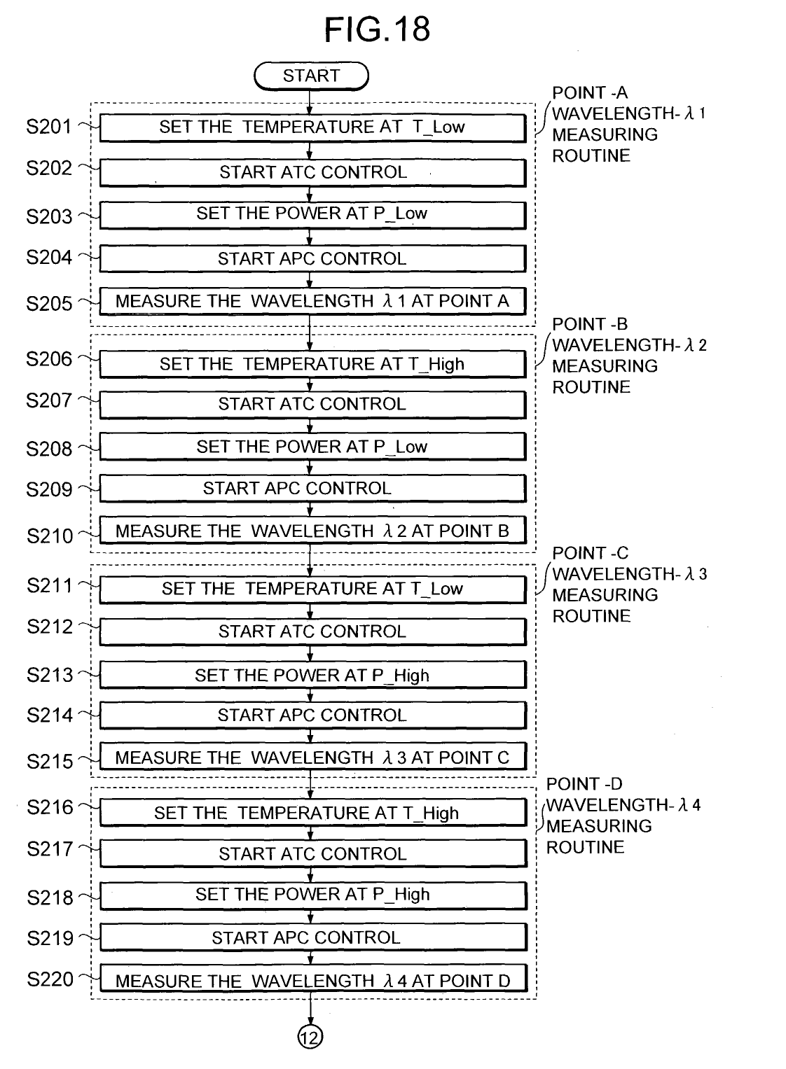

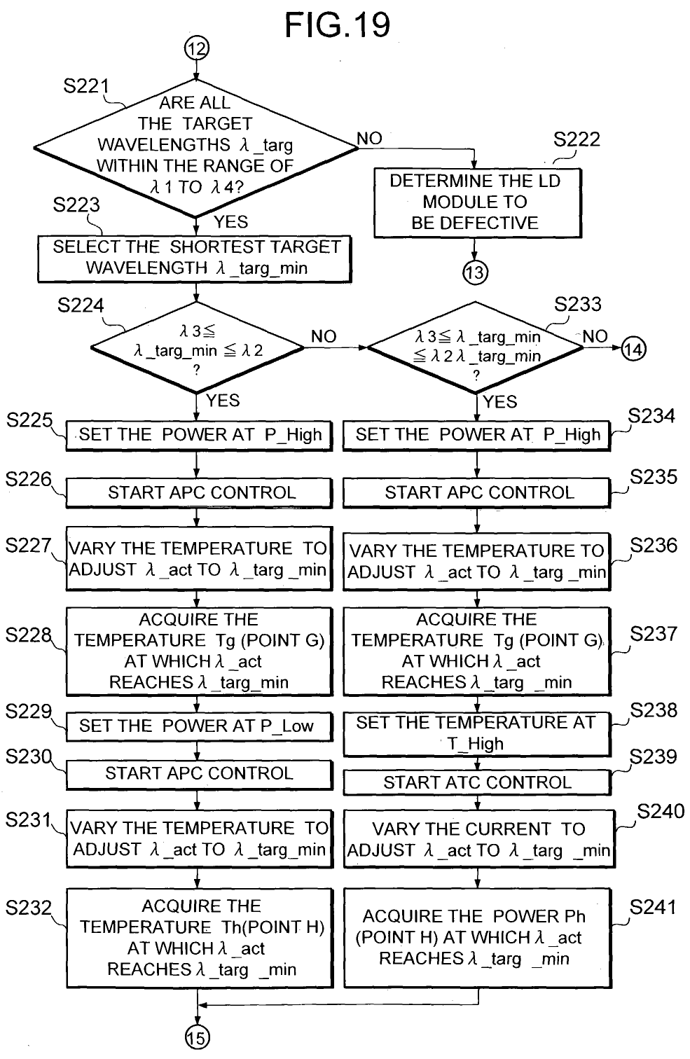

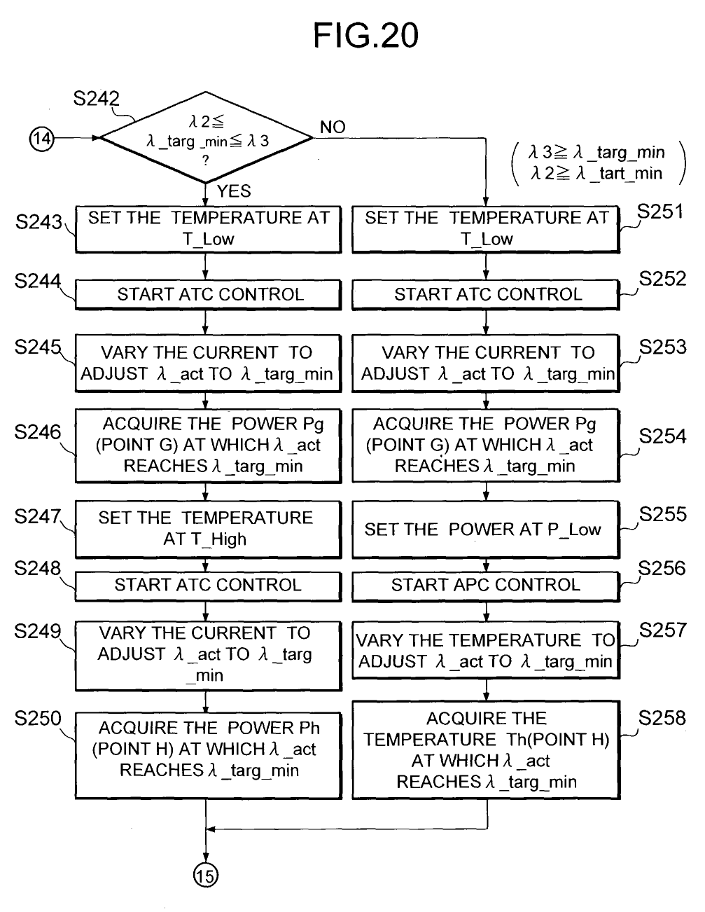

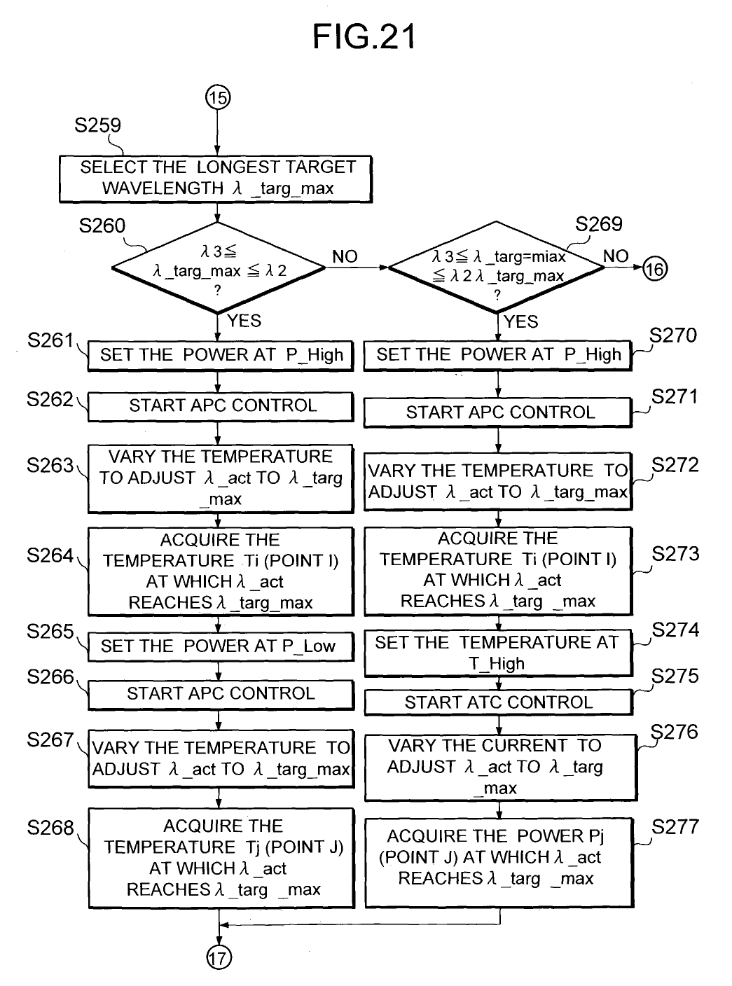

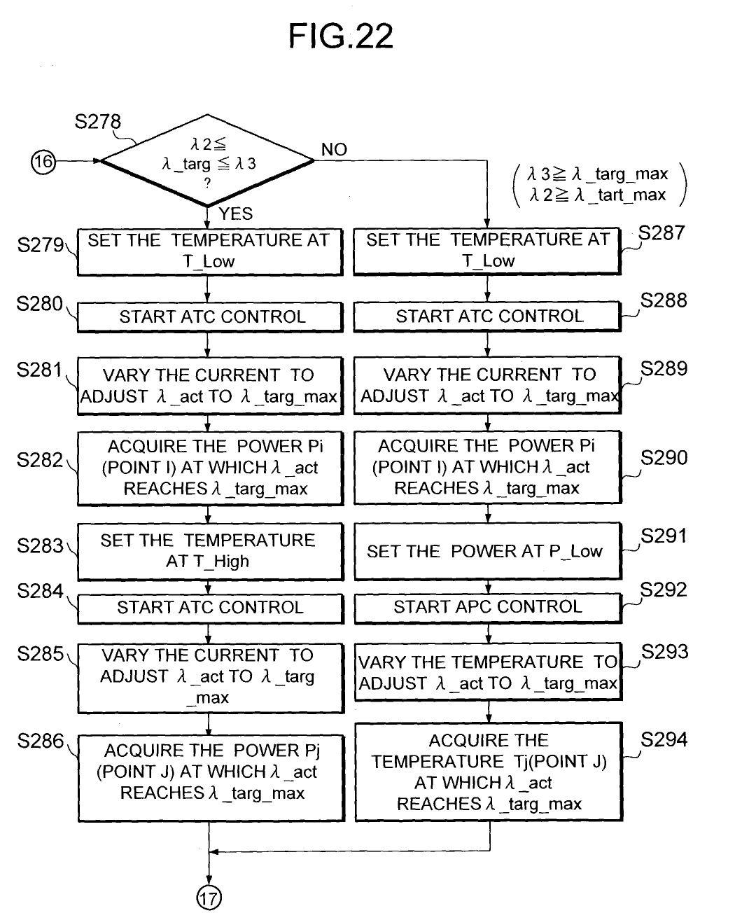

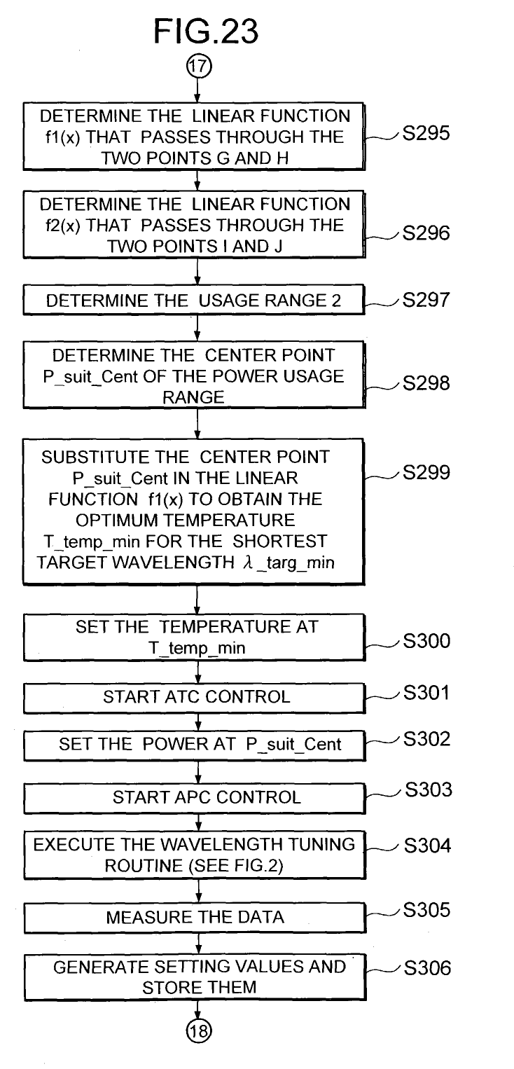

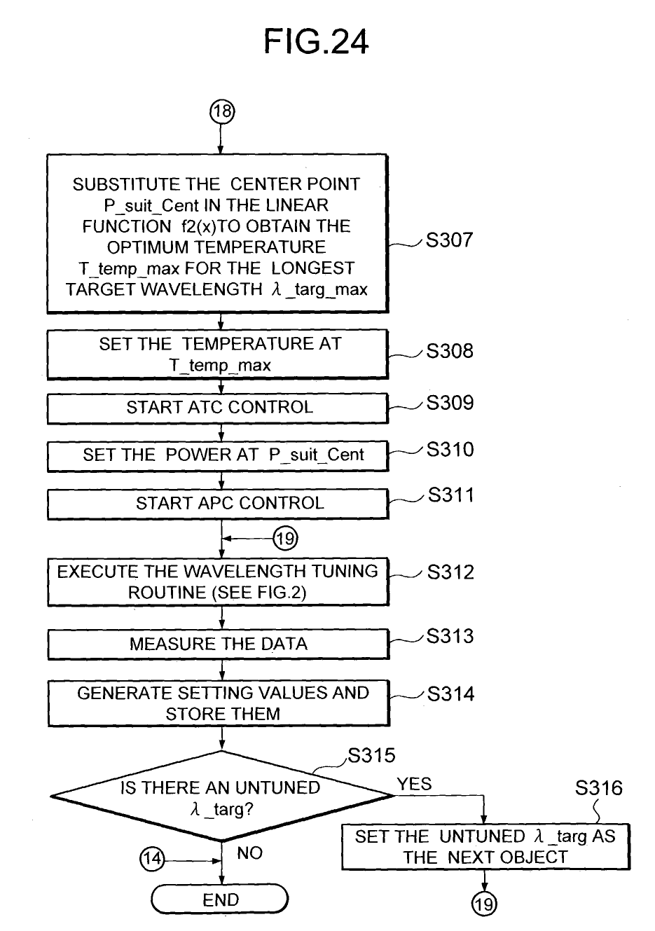

In the following, an operation to be performed by the measurement controlling computer 5 to generate setting values will be described in detail, with reference to FIGS. 18 through 24.

As in the first embodiment, the measurement controlling computer 5 first executes the point-A wavelength λ1 measuring routine of steps S201 through S205, the point-B wavelength λ2 measuring routine of steps S206 through S210, the point-C wavelength λ3 measuring routine of steps S211 through S215, and the point-D wavelength λ4 measuring routine of steps S216 through S220, in this order, to thereby measure the wavelengths λ1 through λ4 at the points A through D (see FIG. 10A).

After measuring the wavelengths λ1 through λ4 at the points A through D, the measurement controlling computer 5 determines whether all the target wavelengths λ_targ (λ_targ_min through λ_targ_max) to be set in the LD module 11 are within the range of the wavelength λ1 to the wavelength λ4 (step S221). By doing so, the measurement controlling computer 5 determines whether setting values can be obtained for all the target wavelengths of the LD module 11 in accordance with this embodiment. If one or more of the target wavelengths are not within the range of λ1 to λ4 (“No” in step S221), the measurement controlling computer 5 determines that the LD module 11 is defective (step S222), and ends the operation.

If all the target wavelengths λ_targ are within the range of λ1 to λ4 (“Yes” in step S221), the measurement controlling computer 5 determines the powers and the temperatures at the two points G and H shown in FIG. 17.

More specifically, the measurement controlling computer 5 first selects the shortest target wavelength λ_targ_min (step S223), and determines whether the shortest target wavelength λ_targ_min is within the range of λ3 to λ2 (step S224). By doing so, the measurement controlling computer 5 determines whether the function λ_targ_min_CONST for maintaining the shortest target wavelength λ_targ_min crosses the boundary lines of the region in which the temperature variable range and the power variable range overlap each other in the same manner as the function λ_CONST shown in FIG. 10B.

If the shortest target wavelength λ_targ min is within the range of λ3 to λ2 (“Yes” in step S224), the measurement controlling computer 5 sets the power upper limit value P_High in the laser APC power source monitoring device 102 (step S225), and causes the laser APC power source monitoring device 102 to start APC control based on the power P_High (step S226). The measurement controlling computer 5 then varies the temperature under the APC control, so that the actual measured wavelength λ_act becomes equal to the shortest target wavelength λ_targ_min (step S227). The measurement controlling computer 5 acquires the temperature Tg at which the actual measured wavelength λ_act reaches the shortest target wavelength λ_targ min (step S228). Through the above procedures, the measurement controlling computer 5 acquires the power P_High and the temperature Tg at the point G, shown in FIG. 17, with respect to the shortest target wavelength λ_targ_min.

The measurement controlling computer 5 next sets the power at P_Low (step S229), and causes the laser APC power source monitoring device 102 to start APC control based on the power P_Low (step S230). After that, the measurement controlling computer 5 varies the temperature under the APC control, so that the actual measured wavelength λ_act becomes equal to the shortest target wavelength λ_targ_min (step S231). The measurement controlling computer 5 then acquires the temperature Th at which the actual measured wavelength λ_act reaches the shortest target wavelength λ_targ_min (step S232). Through the above procedures, the measurement controlling computer 5 acquires the power P_Low and the temperature Th at the point H, shown in FIG. 17, with respect to the shortest target wavelength λ_targ_min.

In this manner, the two points G and H, at which the function λ_targ_min _CONST for maintaining the shortest target wavelength λ_targ_min crosses the boundary lines of the region in which the temperature variable range and the power variable range overlap each other, as shown in FIG. 17, are determined.

Meanwhile, if the shortest target wavelength λ_targ_min is not within the range of λ3 to λ2 (“No” in step S224), the measurement controlling computer 5 determines whether the shortest target wavelength λ_targ_min is longer than both λ3 and λ2 (step S233). By doing so, the measurement controlling computer 5 determines whether the function λ_targ_min_CONST for maintaining the shortest target wavelength λ_targ_min crosses the boundary lines of the region in which the temperature variable range and the power variable range overlap each other in the same manner as the function λ_CONST shown in FIG. 10C.

If the shortest target wavelength λ_targ_min is longer than both λ3 and λ2 (“Yes” in step S233), the measurement controlling computer 5 sets the power upper limit P_High in the laser APC power source monitoring device 102 (step S234), and causes the laser APC power source monitoring device 102 to start APC control based on the power P_High (step S235). After that, the measurement controlling computer 5 varies the temperature under the APC control, so that the actual measured wavelength λ_act becomes equal to the shortest target wavelength λ_targ_min (step S236). The measurement controlling computer 5 then acquires the temperature Tg at which the actual measured wavelength λ_act reaches the shortest target wavelength λ_targ_min (step S237). Through the above procedures, the measurement controlling computer 5 acquires the power P_High and the temperature Tg at the point G shown in FIG. 17.

The measurement controlling computer 5 next sets the temperature at T_High (step S238), and causes the laser temperature control monitoring device 103 to start ATC control based on the temperature T_High (step S239). The measurement controlling computer 5 then varies the drive current of the LD module 11 under the ATC control, so that the actual measured wavelength λ_act becomes equal to the shortest target wavelength λ_targ_min (step S240). The measurement controlling computer 5 then acquires the power Ph with which the actual measured wavelength λ_act reaches the shortest target wavelength λ_targ_min (step S241). Through these procedures, the measurement controlling computer 5 acquires the power Ph and the temperature T_High at the point H shown in FIG. 17.

In this manner, the two points G and H, at which the function λ_targ_min_CONST for maintaining the shortest target wavelength λ_targ_min crosses the boundary lines of the region in which the temperature variable range and the power variable range overlap each other, as shown in FIG. 17, are determined.

Meanwhile, if the shortest target wavelength λ_targ min is not longer than both λ3 and λ2 (“No” in step S233), the measurement controlling computer 5 determines whether the shortest target wavelength λ_targ_min is within the range of λ2 to λ3 (step S242). By doing so, the measurement controlling computer 5 determines whether the function λ_targ_min_CONST for maintaining the shortest target wavelength λ_targ min crosses the boundary lines of the region in which the temperature variable range and the power variable range overlap each other in the same manner as the function λ_CONST shown in FIG. 10D.

If the shortest target wavelength is within the range of λ2 to λ3 (“Yes” in step S242), the measurement controlling computer 5 sets the temperature lower limit value T_Low in the laser temperature control monitoring device 103 (step S243), and causes the laser temperature control monitoring device 103 to start ATC control based on the temperature T_Low (step S244). After that, the measurement controlling computer 5 varies the drive current of the LD module 11 under the ATC control, so that the actual measured wavelength λ_act becomes equal to the shortest target wavelength λ_targ_min (step S245). The measurement controlling computer 5 then acquires the power Pg with which the actual measured wavelength λ_act reaches the shortest target wavelength λ_targ_min (step S246). Through these procedures, the measurement controlling computer 5 acquires the power Pg and the temperature T_Low at the point G in FIG. 17.

The measurement controlling computer 5 next sets the temperature at T High (step S247), and causes the laser temperature control monitoring device 103 to start ATC control based on the temperature T_High (step S248). The measurement controlling computer 5 then varies the drive current of the LD module 11 under the ATC control, so that actual measured wavelength λ_act becomes equal to the shortest target wavelength λ_targ_min (step S249). The measurement controlling computer 5 then acquires the power Ph with which the actual measured wavelength λ_act reaches the shortest target wavelength λ_targ_min (step S250). Through these procedures, the measurement computer 5 acquires the power Ph and the temperature T_High at the point H in FIG. 17.

In this manner, the two point G and H, at which the function λ_targ_min _CONST for maintaining the shortest target wavelength λ_targ_min crosses the boundary lines of the region in which the temperature variable range and the power variable range overlap each other, as shown in FIG. 17, are determined.

Meanwhile, if the shortest target wavelength λ_targ_min is not within the range of λ2 to λ3 (“No” in step S242), the shortest target wavelength λ_targ min must be shorter than both λ3 and λ2, which is the only one remaining option for the shortest target wavelength λ_targ_min. Here, the measurement controlling computer 5 carries out the following procedures. In these procedures, it is assumed that the function λ_targ _min CONST for maintaining the shortest target wavelength λ_targ_min crosses the boundary lines of the region in which the temperature variable range and the power variable range overlap each other in the same manner as the function _CONST shown in FIG. 10E.

More specifically, the measurement controlling computer 5 sets the temperature lower limit value T_Low in the laser temperature controlling monitoring device 103 (step S251), and causes the laser temperature control monitoring device 103 to start ATC control based on the temperature T_Low (step S252). After that, the measurement controlling computer 5 varies the drive current of the LD module 11 under the ATC control, so that the actual measured wavelength λ_act becomes equal to the shortest target wavelength λ_targ_min (step S253). The measurement controlling computer 5 then acquires the power Pg with which the actual measured wavelength λ_act reaches the shortest target wavelength λ_targ_min (step S254). Through these procedures, the measurement controlling computer 5 acquires the power Pg and the temperature T_Low at the point G in FIG. 17.

The measurement controlling computer 5 next sets the power at P_Low (step S255), and causes the laser APC power source monitoring device 102 to start APC control based on the power P_Low (step S256). After that, the measurement controlling computer 5 varies the temperature under the APC control, so that the actual measured wavelength λ_act becomes equal to the shortest target wavelength λ_targ_min (step S257). The measurement controlling computer 5 then acquires the temperature Th at which the actual measured wavelength λ_act reaches the shortest target wavelength λ_targ_min (step S258). Through these procedures, the measurement controlling computer 5 acquires the power P_Low and the temperature Th at the point H in FIG. 17.

In this manner, the two points G and H, at which the function λ_targ_min_CONST for maintaining the shortest target wavelength λ_targ_min crosses the boundary lines of the region in which the temperature variable range and the power variable range overlap each other, as shown in FIG. 17, are determined.

After determining the powers and the temperatures at the two points G and H shown in FIG. 17 through the above procedures, the measurement controlling computer 5 next determines the powers and the temperatures at the two points I and J shown in FIG. 17.

More specifically, the measurement controlling computer 5 first selects the longest target wavelength λ_targ_max (step S259). The measurement controlling computer 5 then determines whether the longest target wavelength λ_targ_max is within the range of λ3 to λ2 (step S260). Through these procedures, the measurement controlling computer 5 determines whether the function λ_targ_max_CONST for maintaining the longest target wavelength λ_targ_max crosses the boundary lines of the region in which the temperature variable range and the power variable range overlap each other in the same manner as the function λ_CONST shown in FIG. 10B.

If the longest target wavelength λ_targ_max is within the range of λ3 to λ2 (“Yes” in step S260), the measurement controlling computer 5 sets the power upper limit value P_High in the laser APC power source monitoring device 102 (step S261), and causes the laser APC power source monitoring device 102 to start APC control based on the power P_High (step S262). After that, the measurement controlling computer 5 varies the temperature under the APC control, so that the actual measured wavelength λ_act becomes equal to the longest target wavelength λ_targ_max (step S263). The measurement controlling computer 5 then acquires the temperature Ti at which the actual measured wavelength λ_act reaches the longest target wavelength λ_targ_max (step S264). Through these procedures, the measurement controlling computer 5 acquires the power P_High and the temperature Ti at the point I in FIG. 17.

The measurement controlling computer 5 next sets the power at P_Low (step S265), and causes the laser APC power source monitoring device 102 to start APC control based on the power P_Low (step S266). After that, the measurement controlling computer 5 varies the temperature under the APC control, so that the actual measured wavelength λ_act becomes equal to the longest target wavelength λ_targ_max (step S267). The measurement controlling computer 5 then acquires the temperature Tj at which the actual measured wavelength λ_act reaches the longest target wavelength λ_targ_max (step S268). Through these procedures, the measurement controlling computer 5 acquires the power P_Low and the temperature Tj at the point J, shown in FIG. 17, with respect to the longest target wavelength λ_targ_max.

In this manner, the two points I and J, at which the function λ_targ_max_CONST for maintaining the longest target wavelength λ_targ_max crosses the boundary lines of the region in which the temperature variable range and the power variable range overlap each other, as shown in FIG. 17, are determined.

Meanwhile, if the longest target wavelength λ_targ_max is not within the range of λ3 to λ2 (“No” in step S260), the measurement controlling computer 5 determines whether the longest target wavelength λ_targ_max is longer than both λ3 and λ2 (step S269). Through this procedure, the measurement controlling computer 5 determines whether the function λ_targ_max_CONST for maintaining the longest target wavelength λ_targ_max crosses the boundary lines of the region in which the temperature variable range and the power variable range overlap each other in the same manner as the function λ_CONST shown in FIG. 10C.

If the longest target wavelength λ_targ_max is longer than both λ3 and λ2 (“Yes” in step S269), the measurement controlling computer 5 sets the power upper limit value P_High in the laser APC power source monitoring device 102 (step S270), and causes the laser APC power source monitoring device 102 to start APC control based on the power P_High (step S271). After that, the measurement controlling computer 5 varies the temperature under the APC control, so that the actual measured wavelength λ_act becomes equal to the longest target wavelength λ_targ_max (step S272). The measurement controlling computer 5 then acquires the temperatures Ti at which the actual measured wavelength λ_act reaches the longest target wavelength λ_targ_max (step S273). Through these procedures, the measurement controlling computer 5 acquires the power P_High and the temperature Ti at the point I in FIG. 17.

The measurement controlling computer 5 next sets the temperature at T_High (step S274), and causes the laser temperature control monitoring device 103 to start ATC control based on the temperature T High (step S275). After that, the measurement controlling computer 5 varies the drive current of the LD module 11 under the ATC control, so that the actual measured wavelength λ_act becomes equal to the longest target wavelength λ_targ_max (step S276). The measurement controlling computer 5 then acquires the power Pj with which the actual measured wavelength λ_act reaches the longest target wavelength λ_targ_max (step S277). Through these procedures, the measurement controlling computer 5 acquires the power Pj and the temperature T_High at the point J in FIG. 17.

In this manner, the two points I and J, at which the function λ_targ_max CONST for maintaining the longest target wavelength λ_targ_max crosses the boundary lines of the region in which the temperature variable range and the power variable range overlap each other, as shown in FIG. 17, are determined.

Meanwhile, if the longest target wavelength λ_targ_max is not longer than both λ3 and λ2 (“No” in step S269), the measurement controlling computer 5 determines whether the longest target wavelength λ_targ_max is within the range of λ2 to λ3 (step S278). Through this procedure, the measurement controlling computer 5 determines whether the function λ_targ_max_CONST for maintaining the longest target wavelength λ_targ_max crosses the boundary lines of the region in which the temperature variable range and the power variable range overlap each other in the same manner as the function λ_CONST shown in FIG. 10D.

If the longest target wavelength λ_targ_max is within the range of λ2 to λ3 (“Yes” in step S278), the measurement controlling computer 5 sets the temperature lower limit value T_Low in the laser temperature control monitoring device 103 (step S279), and causes the laser temperature control monitoring device 103 to start ATC control based on the temperature T_Low (step S280). After that, the measurement controlling computer 5 varies the drive current of the LD module 11 under the ATC control, so that the actual measured wavelength λ_act becomes equal to the longest target wavelength λ_targ_max (step S281). The measurement controlling computer 5 then acquires the power Pi with which the actual measured wavelength λ_act reaches the longest target wavelength λ_targ_max (step S282). Through these procedures, the measurement controlling computer 5 acquires the power Pi and the temperature T_Low at the point I in FIG. 17.

The measurement controlling computer 5 next sets the temperature at T_High (step S283), and causes the laser temperature control monitoring device 103 to start ATC control based on the temperature T_High (step S284). After that, the measurement controlling computer 5 varies the drive current of the LD module 11 under the ATC control, so that the actual measured wavelength λ_act becomes equal to the longest target wavelength λ_targ_max (step S285). The measurement controlling computer 5 then acquires the power Pj with which the actual measured wavelength λ_act reaches the longest target wavelength λ_targ_max (step S286). Through these procedures, the measurement controlling computer 5 acquires the power Pj and the temperature T_High at the point J in FIG. 17.

In this manner, the two points I and J, at which the function λ_targ_max CONST for maintaining the longest target wavelength λ_targ_max crosses the boundary lines of the region in which the temperature variable range and the power variable range overlap each other, as shown in FIG. 17, are determined.

Meanwhile, if the longest target wavelength λ_targ_max is not within the range of λ2 to λ3 (“No” in step S278), the longest target wavelength λ_targ_max must be shorter than both λ3 and λ2, which is the only one remaining option for the longest target wavelength λ_targ_max. In this case, the measurement controlling computer 5 carries out the following procedures. In these procedures, it is assumed that the function targ_max_CONST for maintaining the longest target wavelength λ_targ_max crosses the boundary lines of the region in which the temperature variable range and the power variable range overlap each other in the same manner as the function λ_CONST shown in FIG. 10E.

More specifically, the measurement controlling computer 5 sets the temperature lower limit value T_Low in the laser temperature control monitoring device 103 (step S287), and causes the laser temperature control monitoring device 103 to start ATC control based on the temperature T_Low (step S288). After that, the measurement controlling computer 5 varies the drive current of the LD module 11 under the ATC control, so that the actual measured wavelength λ_act becomes equal to the longest target wavelength λ_targ_max (step S289). The measurement controlling computer 5 then acquires the power Pi with which the actual measured wavelength λ_act reaches the longest target wavelength λ_targ_max (step S290). Through these procedures, the measurement controlling computer 5 acquires the power Pi and the temperature T_Low at the point I in FIG. 17.

The measurement controlling computer 5 next sets the power at P_Low (step S291), and causes the laser APC power source monitoring device 102 to start APC control based on the power P_Low (step S292). After that, the measurement controlling computer 5 varies the temperature under the APC control, so that the actual measured wavelength λ_act becomes equal to the longest target wavelength λ_targ_max (step S293). The measurement controlling computer 5 then acquires the temperature Tj at which the actual measured wavelength λ_act reaches the longest target wavelength λ_targ_max (step S294). Through these procedures, the measurement controlling computer 5 acquires the power P_Low and the temperature Tj at the point J in FIG. 17.

In this manner, the two points I and J, at which the function λ_targ_max_CONST for maintaining the longest target wavelength λ_targ_max crosses the boundary lines of the region in which the temperature variable range and the power variable range overlap each other, as shown in FIG. 17, are determined.

The power at the point G in FIG. 17 represents the upper limit value of the power that can be used as a setting value for controlling the LD module 11 in this embodiment. The power at the point J represents the lower limit value of the power that can be employed as a setting value for controlling the LD module 11 in this embodiment.

After determining the four points G, H, I, and J through the above procedures, the measurement controlling computer 5 defines a linear formula f1(x) that passes through the two points G and H (step S295). This straight line represents the shortest target wavelength relational expression λ_targ min CONST. In short, the procedure of step S295 realizes the means to define the shortest target wavelength relational expression.

The measurement controlling computer 5 also defines a linear formula f2(x) that passes through the two points I and J (step S295). This straight line represents the longest target wavelength relational expression λ_targ_max CONST. In short, the procedure of step S296 realizes the means to define the longest target wavelength relational expression.

After defining the shortest target wavelength relational expression f1(x) and the longest target wavelength relational expression f2(x) in this manner, the measurement control computer 5 determines the power usage range 2 in FIG. 17 (step S297). More specifically, the usage range 2 is defined by determining the upper limit value of the power that satisfies the shortest target wavelength relational expression f1(x), the temperature variable range, and the power variable range, and the lower limit value of the power that satisfies the longest target wavelength relational expression f2(x), the temperature variable range, and the power variable range. The procedure of step S297 realizes the means to calculate the upper limit value and the lower limit value of the power.

After defining the usage range 2, the measurement controlling computer 5 determines the power optimum point P_suit_Cent, which is the center point of the power in the usage range 2 (step S298). In short, the procedure of step S298 realizes the means to calculate an optimum power. The measurement controlling computer 5 also substitute the power optimum point P suit_Cent in the function f1(x) to obtain the optimum temperature T_temp_min with respect to the shortest target wavelength λ_targ_min (step S299). In short, the procedure of step S299 realizes the means to calculate an optimum temperature.

After determining the power optimum point P_suit_Cent and the optimum temperature T_temp_min with respect to the shortest target wavelength λ_targ_min, the measurement controlling computer 5 sets the temperature at T_temp_min (step S300), and causes the laser temperature control monitoring device 103 to start ATC control based on the temperature T_temp_min (step S301). The measurement controlling computer 5 also sets the power at P suit_Cent (step S302), and causes the laser APC power source monitoring device 102 to start APC control based on the power P_suit_Cent (step S303).

The measurement controlling computer 5 then executes the wavelength tuning routine 1.(see FIG. 2) to tune the actual measured wavelength λ_act to the shortest target wavelength λ_targ_min (step S304). Here, the initial wavelength W1 is not a wavelength based on the initial temperature T1 and the center P_Cent of the power variable range, but is a wavelength based on the power optimum point P_suit_Cent and the optimum temperature T_temp_min determined through the above procedures.

After tuning the light output of the LD module 11 into an error range of the shortest target wavelength λ_targ_min in the above manner, the measurement controlling computer 5 measures the actual power and temperature (which are the setting values) and the other characteristics of the laser light under this condition (step S305). The measurement controlling computer 5 also generates setting values based on the measured data. The measurement controlling computer 5 then relates the setting values to the identification number of the LD module 11, and stores the setting values in a predetermined file (step S306).

The measurement controlling computer 5 next substitutes the power optimum point P suit_Cent in the function f2(x) to determine the optimum temperature T_temp_max with respect to the longest target wavelength λ_targ_max (step S307).

After determining the power optimum point P_suit_Cent and the optimum temperature T temp max with respect to the longest target wavelength λ_targ_max in the above manner, the measurement controlling computer 5 sets the temperature at T_temp_max (step S308), and causes the laser temperature control monitoring device 103 to start ATC control based on the temperature T_temp_max (step S309). The measurement controlling computer 5 also sets the power at P_suit_Cent (step S310), and causes the laser APC power source monitoring device 102 to start APC control based on the power P_suit_Cent (step S311).

The measurement controlling computer 5 then executes the wavelength tuning routine 1 (see FIG. 2) to tune the actual measured wavelength λ_act to the longest target wavelength λ_targ_max. Here, the initial wavelength W1 is not a wavelength based on the initial temperature T1 and the center P_Cent of the power variable range, but is a wavelength based on the power optimum point P_suit_Cent and the optimum temperature T_temp max.

After tuning the light output of the LD module 11 into an error range of the longest target wavelength λ_targ_max in the above manner, the measurement controlling computer 5 measures the actual power and temperature (which are the setting values) and the other characteristics of the laser light under this condition (step S313). The measurement controlling computer 5 also generates setting values based on the measured data. The measurement controlling computer 5 then relates the setting values to the identification number of the LD module 11, and stores the setting values in a predetermined file (step S314).

Through the wavelength turning routines in steps S304 and S312, temperature narrowing is performed based on the optimum temperatures T_temp_min and T_temp_max, accurate setting temperatures can be readily obtained.

After storing the setting values with respect to the shortest target wavelength λ_targ_min and the longest target wavelength λ_targ_max in the above manner, the measurement controlling computer 5 determines whether any untuned target wavelength λ_targ exists in the same LD module 11 (step S315).

If there is an untuned target wavelength λ_targ (“Yes” in step S315), the measurement controlling computer 5 moves on to step S316, and sets the untuned target wavelength λ_targ as the next object. The measurement controlling computer 5 then returns to step S312, and generates and stores setting value in a predetermined file in the same manner as above. Meanwhile, if an untuned target wavelength λ_targ does not exist (“No” in step S315), the measurement controlling computer 5 ends the operation.

Through the above operation, setting values for enabling the LD module 11 to emit laser light of varied wavelengths can be generated with a single power. The setting values generated in the above manner are stored in the WDM wavelength locking condition memory 16 shown in FIG. 11, which is the same as in the first embodiment. In this case, the LD modules 11.1 through 11.n function as the wavelength-variable LD module 11. It should be noted that the other parts of the structure are the same as those in the first embodiment, and expiation of them is omitted herein.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An optical communication module that emits laser light having a wavelength depending on temperature and power intensity, comprising:
a laser light emitting unit that emits the laser light;
a temperature control unit that controls the temperature of the laser light emitting unit;
a power intensity control unit that controls the power intensity of the laser light emitted from the laser light emitting unit; and
a setting value storage unit that stores a setting value determined from an optimum power intensity that maintains a predetermined wavelength and satisfies predetermined temperature conditions and predetermined power intensity conditions, and from an optimum temperature that maintains the predetermined wavelength and satisfies the predetermined temperature conditions and the predetermined power intensity conditions;
the temperature control unit and the power intensity control unit controlling the temperature and the power intensity of the laser light emitting unit, based on the setting value stored in the setting value storage unit.

2. The optical communication module as claimed in claim 1, wherein:
the laser light emitting unit can vary wavelengths; and
the setting value storage unit stores a setting value for each of the wavelengths.

3. The optical communication module as claimed in claim 1, comprising two or more laser light emitting units, each of which being the same as the laser light emitting unit, two or more temperature control units, each of which being the same as the temperature control unit, and two or more power intensity control units, each of which being the same as the power intensity control unit.

4. The optical communication module as claimed in claim 1, wherein:
the temperature control unit includes a temperature sensor provided in a laser module into which laser diodes are incorporated, a cooling/heating device provided in the laser module, and a temperature drive circuit for driving the cooling/heating device so that a temperature detected by the temperature sensor satisfies the setting value; and
the power intensity control unit includes a photodetector provided inside and/or outside the laser module, a laser drive circuit for inputting drive current to the laser diodes, and a power intensity control circuit for controlling the laser drive circuit so that a power intensity detected by the photodetector satisfies the setting value.

5. A wavelength locker module that causes laser light emitted from a laser module to maintain a predetermined wavelength, comprising:
a temperature control unit that controls the temperature of the laser module;
a power intensity control unit that controls the power intensity of the laser light emitted from the laser module; and
a setting value storage unit that stores a setting value determined from an optimum power intensity that maintains the predetermined wavelength and satisfy predetermined temperature conditions and predetermined power intensity conditions, and from an optimum temperature that maintains the predetermined wavelength and satisfy the predetermined temperature conditions and the predetermined power intensity conditions,
the temperature control unit and the power intensity control unit controlling the temperature and the power intensity of the laser module, based on the setting value stored in the setting value storage unit, to thereby cause the laser light to maintain the predetermined wavelength.

6. The wavelength locker module as claimed in claim 5, wherein:
the laser module includes a variable-wave laser; and
the setting value storage unit stores a setting value for each wavelength.

7. The wavelength locker module as claimed in claim 5, comprising two or more temperature control units, each of which being the same as the temperature control unit, and two or more power intensity control units, each of which being the same as the power intensity control unit.

8. The wavelength locker module as claimed in claim 5, wherein:
the temperature control unit includes a temperature monitor circuit for monitoring the temperature of the laser module based on a temperature sensor provided in the laser module, a cooling/heating device drive circuit for driving a cooling/heating device provided in the laser module, and a temperature control circuit for controlling the cooling/heating device drive circuit so that the temperature monitored by the temperature monitor circuit satisfies the setting value; and
the power intensity control unit includes a photodetector provided inside and/or outside the laser module, a laser drive circuit for inputting drive current to laser diodes, and a power intensity control circuit for controlling the laser drive circuit so that a power intensity detected by the photodetector satisfies the setting value.

9. A setting value generating device that generates such a setting value that causes laser light emitted from a laser module to have a predetermined wavelength and satisfies predetermined temperature conditions and predetermined power intensity conditions,
the setting value generating device comprising:
an optimum power intensity calculating unit that calculates an optimum power intensity that maintains the predetermined wavelength and satisfies the predetermined temperature conditions and the predetermined power intensity conditions;
an optimum temperature calculating unit that calculates an optimum temperature that maintains the predetermined wavelength and satisfies the predetermined temperature conditions and the predetermined power intensity conditions; and
a setting value generating unit that generates the setting value based on the optimum power intensity calculated by the optimum power intensity calculating unit and the optimum temperature calculated by the optimum temperature calculating unit.

10. The setting value generating device as claimed in claim 9, further comprising:
a relational expression defining unit that defines a relational expression between a temperature and a power intensity that causes the laser module to maintain the predetermined wavelength; and
a power intensity upper and lower limit calculating/defining unit that calculates or defines an upper limit value and a lower limit value of a power intensity that satisfies the relational expression and also satisfies the predetermined temperature conditions and the predetermined power intensity conditions,
wherein:
the optimum power intensity calculating unit calculates the optimum power intensity that is the middle value between the upper limit value and the lower limit value of the power intensity defined by the power intensity upper and lower limit calculating/defining unit; and
the optimum temperature calculating unit substitutes the optimum power intensity calculated by the optimum power intensity calculating unit in the relational expression defined by the relational expression defining unit, to thereby calculate the optimum temperature.

11. The setting value generating device as claimed in claim 10, wherein:
the laser module can vary wavelengths; and
the setting value is generated in relation with each of the wavelengths.

12. The setting value generating device as claimed in claim 9, the laser module being able to vary wavelengths, further comprising:
a shortest wavelength relational expression defining unit that defines a shortest wavelength relational expression that represents the relationship between a temperature and a power intensity for causing the laser module to maintain a shortest predetermined wavelength:
a longest wavelength relational expression defining unit that defines a longest wavelength relational expression that represents the relationship between a temperature and a power intensity for causing the laser module to maintain a longest predetermined wavelength;
a power intensity upper limit value calculating/defining unit that calculates or defines an upper limit value of a power intensity that satisfies the shortest wavelength relational expression and also satisfies the predetermined temperature conditions and the predetermined power intensity conditions; and
a power intensity lower limit value calculating/defining unit that calculates or defines a lower limit value of a power intensity that satisfies the longest wavelength relational expression and also satisfies the predetermined temperature conditions and the predetermined power intensity conditions,
wherein:
the optimum power intensity calculating unit calculates the optimum power intensity, which is the middle value between the upper limit value of the power intensity determined by the power intensity upper limit value calculating/defining unit and the lower limit value of the power intensity determined by the power intensity lower limit value calculating/defining unit;
the optimum temperature calculating unit calculates the optimum temperature with respect to the shortest predetermined wavelength and/or the longest predetermined wavelength by substituting the optimum power intensity, calculated by the optimum power intensity calculating unit, in the shortest wavelength relational expression and/or the longest wavelength relational expression; and
the setting value generating unit generates the setting value for all predetermined wavelengths, based on the optimum power intensity and the optimum temperature calculated with respect to the shortest predetermined wavelength or the longest predetermined wavelength.

13. The setting value generating device as claimed in claim 9, further comprising
a setting value storage unit that stores the setting value generated by the setting value generating unit,
wherein:
the laser module contains unique identification information; and
the setting value storage unit relates the setting value to the unique identification information, and stores the setting value.

14. A method of generating a setting value in an information processing device that generates such a setting value that causes laser light emitted from a laser module to have a predetermined wavelength, and satisfies predetermined temperature conditions and predetermined power intensity conditions,
the method comprising the steps of:
calculating an optimum power intensity that maintains the predetermined wavelength and satisfies the predetermined temperature conditions and the predetermined power intensity conditions;
calculating an optimum temperature that maintains the predetermined wavelength and satisfies the predetermined temperature conditions and the predetermined power intensity conditions; and
generating the setting value based on the optimum power intensity and the optimum temperature calculated in the foregoing steps.

15. The method as claimed in claim 14, further comprising the steps of:
defining a relational expression between a temperature and a power intensity that cause the laser module to maintain the predetermined wavelength; and
calculating or defining an upper limit value and a lower limit value of a power intensity that satisfies the relational expression and also satisfies the predetermined temperature conditions and the predetermined power intensity conditions,
wherein:
the step of calculating the optimum power intensity includes calculating the middle value between the upper limit value and the lower limit value of the output value, the middle value being the optimum power intensity; and
the step of calculating the optimum temperature includes substituting the optimum power intensity in the relational expression, to thereby obtain the optimum temperature.

16. The method as claimed in claim 15, wherein:
the laser module can vary wavelengths; and
the setting value is generated in relation with each of the wavelengths.

17. The method as claimed in claim 14, the laser module being able to vary wavelengths, further comprising the steps of:
defining a shortest wavelength relational expression that represents the relationship between a temperature and a power intensity for causing the laser module to maintain a shortest predetermined wavelength;
defining a longest wavelength relational expression that represents the relationship between a temperature and a power intensity for causing the laser module to maintain a longest predetermined wavelength;
calculating or defining an upper limit value of a power intensity that satisfies the shortest wavelength expression and also satisfies the predetermined temperature conditions and the predetermined power intensity conditions; and
calculating or defining a lower limit value of a power intensity that satisfies the longest wavelength relational expression and also satisfies the predetermined temperature conditions and the predetermined power intensity conditions,
wherein:
the step of calculating the optimum power intensity includes calculating the middle value between the upper limit value of the power intensity determined in the step of calculating or defining the power intensity upper limit value, and the lower limit value of the power intensity determined in the step of calculating or defining the power intensity lower limit value, the middle value representing the optimum power intensity;
the step of calculating the optimum temperature includes substituting the optimum power intensity, calculated in the step of calculating the optimum power intensity, in the shortest wavelength relational expression and/or the longest wavelength relational expression, to thereby calculate the optimum temperature with respect to the shortest predetermined wavelength and/or longest predetermined wavelength; and
the step of generating the setting value includes generating the setting value for all predetermined wavelengths, based on the optimum power intensity and the optimum temperature calculated with respect to the shortest predetermined wavelength or the longest predetermined wavelength.

18. The method as claimed in claim 14, the laser module containing unique identification information,
the method further comprising the step of
storing the setting value that is related to the unique identification information.

19. A program product for causing a computer to generate such a setting value that causes laser light emitted from a laser module to have a predetermined wavelength and satisfies predetermined temperature conditions and predetermined power intensity conditions,
the program product comprising:
instructions for calculating an optimum power intensity that maintains the predetermined wavelength and satisfies the predetermined temperature conditions and the predetermined power intensity conditions;
instructions for calculating an optimum temperature that maintains the predetermined wavelength and satisfies the predetermined temperature conditions and the predetermined power intensity conditions; and
instructions for generating the setting value based on the optimum power intensity calculated in accordance with the optimum power intensity calculating instructions, and the optimum temperature calculated in accordance with the optimum temperature calculating instructions.

20. The program product as claimed in claim 19, further comprising:
instructions for defining a relational expression between a temperature and a power intensity that cause the laser module to maintain the predetermined wavelength; and
instructions for calculating or defining an upper limit value and a lower limit value of a power intensity that satisfies the relational expression and also satisfies the predetermined temperature conditions and the predetermined power intensity conditions,
the optimum power intensity calculating instructions include an instruction for calculating the middle value between the upper limit value and the lower limit value of the power intensity calculated in accordance with the instructions for calculating or defining the power intensity upper and lower values, the middle value being the optimum power intensity; and
the optimum temperature calculating instructions include an instruction for substituting the optimum power intensity, calculated in accordance with the instructions for calculating the optimum power intensity, in the relational expression defined in accordance with the instructions for defining the relational expression.

21. The program product as claimed in claim 20, further comprising instructions for generating the setting value in relation to each predetermined wavelength that the laser module can have, the laser module being able to vary wavelengths.

22. The program product as claimed in claim 19, further comprising:
instructions for defining a shortest wavelength relational expression that represents the relationship between a temperature and a power intensity for causing the laser module to maintain a shortest predetermined wavelength;
instructions for defining a longest wavelength relational expression that represents the relationship between a temperature and a power intensity for causing the laser module to maintain a longest predetermined wavelength;
instructions for calculating or defining an upper limit value of a power intensity that satisfies the shortest wavelength relational expression and also satisfies the predetermined temperature conditions and the predetermined power intensity conditions; and
instructions for calculating or defining a lower limit value of a power intensity that satisfies the longest wavelength relational expression and also satisfies the predetermined temperature conditions and the predetermined power intensity conditions,
the computer executing all the forgoing instructions,
wherein:
the optimum power intensity is calculated as the middle value between the upper limit value of the power intensity determined in accordance with the instructions for calculating or defining the power intensity upper limit value, and the lower limit value of the power intensity determined in accordance with the instructions for calculating or defining the power intensity lower limit value;
the optimum temperature with respect to the shortest predetermined wavelength and/or the longest predetermined wavelength is calculated by substituting the optimum power intensity, calculated in accordance with the instructions for calculating the optimum power intensity, in the shortest wavelength relational expression and/or the longest wavelength relational expression; and
the setting value is generated for all predetermined wavelengths, based on the optimum power intensity and the optimum temperature calculated with respect to the shortest predetermined wavelength or the longest predetermined wavelength.

23. The program product as claimed in claim 19, further comprising instructions for storing the setting value that is related to unique identification information allocated to the laser module.

24. A recording medium on which a program for causing a computer to generate such a setting value that causes laser light emitted from a laser module to have a predetermined wavelength and satisfies predetermined temperature conditions and predetermined power intensity conditions, is recorded,
the program comprising:
instructions for calculating an optimum power intensity that maintains the predetermined wavelength and satisfies the predetermined temperature conditions and the predetermined power intensity conditions;
instructions for calculating an optimum temperature that maintains the predetermined wavelength and satisfies the predetermined temperature conditions and the predetermined power intensity conditions; and
instructions for generating the setting value based on the optimum power intensity calculated in accordance with the optimum power intensity calculating instructions and the optimum temperature calculated in accordance with the optimum temperature calculating instructions.
